(19) United States
(12) Patent Application Publication
(10) Pub. No.: US 2007/0235535 A1
(43) Pub. Date: Oct. 11, 2007

(54) Method and software for determining the eligibility of a voter and for providing pollworker training

(76) Inventors: David M. Davoust, Wheaton, IL (US); Robert Saar, Wheaton, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/399,704

(22) Filed: Apr. 5, 2006

(51) Int. Cl. G07C 13/00; G06F 11/00; G06K 17/00

(52) U.S. Cl. 235/386; 705/12

(57) ABSTRACT

Methods and software for determining voter eligibility in an election on an electronic device through decision support program control. The primary method includes confirming the election and an election date on a screen provided by the device, selecting the proper precinct, and selecting a desired voter election decision process from a menu. Other methods include providing a voter lookup screen, initiating a voter lookup search, providing a voter search result list, providing detailed information on a selected voter, providing detailed information for a particular polling place, providing an address lookup screen to determine a voter's correct voting location, providing a broadened search function, identifying that the voter is only eligible to vote provisionally, identifying that the voter is not eligible to vote, providing help information on a topic selected from the menu screen, and displaying an integrated video on a selected election topic.

### FIELD OF THE INVENTION

The present invention relates generally to software and methods for determining the eligibility of a voter.

More particularly, the present invention relates to software and methods for immediately determining the eligibility of a voter at a specific election and for training pollworkers in voting procedures.

### BACKGROUND OF THE INVENTION

The greatest challenge facing election officials is the training of pollworkers. n an effort to make sure that votes are counted correctly, new election laws have been enacted at both the federal and state level which continue to increase the complexity of the election process. For example, in a Federal election, a voter who does not appear on the voter registration lists on Election Day may be able to vote provisionally in their current precinct or return to their previous precinct to vote a Federal Failsafe ballot. If the wrong procedures are followed for a particular voter's circumstances, the voter's ballot might remain uncounted.

Examples of criteria that may affect a voter's eligibility to vote include when and where the voter registered to vote, whether the voter moved residences, whether the voter changed his or her name or whether the voter is discharged from the military. Moreover, the location or procedures that must be followed may also affect whether the vote is eligible to be counted.

Although pollworkers generally desire to assist voters, the wide variety of possibilities, combined with the fact that most of them only deal with election matters one or two days a year, make it very difficult for them to know the correct course of action for each voter or each possibility that may arise.

To date, the primary means for helping pollworkers to determine voter eligibility has been to train the pollworkers before an election on all of the possibilities. Unfortunately, as elections become more complex, this is not a practical solution. For example, currently there are over 100 possible eligibility outcomes in an election in Illinois. Even with the help of printed documentation, the chance for errors is large.

Several products have been offered to provide a way to lookup voters and addresses within the polling place. While these products provide some additional information, they do not guide the pollworker in what to do with that information, nor do they guide the pollworker in the appropriate questions to ask to determine voter eligibility, nor do they help the pollworker to know what procedures to follow to ensure that the voter's ballot will be counted.

In addition, the significant number of voter eligibility issues makes it almost impossible to effectively train a pollworker on all of the possible issues that he or she might face. For example, a pollworker might work on Election Day for many years without ever having a voter whose signature does not match the signature on file. If an unfamiliar situation presents itself, the pollworker needs to know what procedure to follow.

It would be impractical and cumbersome to perform the methods of the present invention by using a set of preprinted documents with a page for each possible question, so that a yes/no question, would present a question with instructions. For example, it might say, “turn to page 100 for YES, or turn to page 101 for NO.” Using documents such as this may guide the pollworker through the process, but also require additional work by the pollworker that is eliminated by the present invention. For example, providing all of the possible paths and permutations of the applicable questions would result in an extremely large and unwieldy set of documents within the polling place. It would also be difficult to keep up to date with changes in laws and procedures with such a preprinted packet of documents, which may also require relatively frequent revisions thereof.

There has therefore been a long-felt need for improved methods of determining voter eligibility, including the ability to quickly and correctly resolve eligibility issues during an election.

A general object of the present invention is to therefore provide improved and effective methods for resolving voter eligibility issues.

Another object of the present invention is to provide software that assists pollworkers in reaching the correct resolution of any voter eligibility issue.

A further object of the present invention is to provide a portable communication device that responds to election-related queries to provide answers to voter eligibility issues.

Yet another object of the present invention is to provide means for training pollworkers in dealing with voter eligibility issues.

A still further object of the present invention is to provide a methods and software for immediately resolving voter eligibility issues at a polling place during the course of an election.

Another object of the present invention is to provide related methods of decision support program control.

### SUMMARY OF THE INVENTION

The present invention is directed to methods for determining voter eligibility in an election on an electronic device, such as a laptop computer or a Pocket PC. The primary method includes the steps of confirming the election and an election date on a screen provided by the device, selecting the proper precinct for the election on a screen provided by the device, and selecting a desired voter election decision process from a menu screen provided by the device. Another method includes the steps of providing a voter lookup screen on the device, initiating a voter lookup search on the device, and providing a voter search result list from conducting a search on the voter lookup screen.

Additional steps include providing detailed information on a selected voter in the voter search result list, responding to a question posed during the election decision process, initiating a broadened voter lookup search on the device, providing a voter search result list from conducting a broadened search on the voter lookup screen, providing detailed information for a particular polling place, providing a screen for responding to a when did you move inquiry, providing a screen for responding to a legal name inquiry, providing an address lookup screen to determine a voter's correct voting location, providing results from the address lookup search, providing results from a broadened address lookup search, providing further detail about a selected voter in the lookup results list, identifying that the voter is eligible to vote in a different precinct as a result of the voter eligibility interview process, identifying that the voter is only eligible to vote provisionally, identifying that the voter is not eligible to vote in this election, providing a menu screen with selectable election help topics, providing help information on a topic selected from the menu screen, displaying an integrated video on a selected election topic.

The present invention is also directed to a computer readable medium, such as a CD, hard drive or other memory storage device, having computer program code, such as a program, stored thereon. The computer program code for determining the eligibility of a voter in an election preferably includes a first code segment for confirming an election and an election date, a second code segment for selecting the proper precinct for the election, and a third code segment for selecting a desired voter election decision process from a menu. The computer program code preferably also includes a fourth code segment for providing a voter lookup screen, a fifth code segment for initiating a voter lookup search, and a sixth code segment for providing a voter search result list.

The computer program code may also include a seventh code segment for providing detailed information on a selected voter in the voter search result list, an eighth code segment for responding to a question posed during the election decision process, a ninth code segment for initiating a broadened voter lookup search; a tenth code segment for providing a broadened voter search results, an eleventh code segment for providing detailed information about a particular polling place, a twelfth code segment for providing a screen in response to a when did you move inquiry, a thirteenth code segment for providing a screen in response to a legal name inquiry, a fourteenth code segment for providing an address lookup screen to determine a voter's correct voting location, a fifteenth code segment for providing results from an address lookup search, a sixteenth code segment for providing further detail about a selected voter in the lookup results list, a seventeenth code segment for identifying that the voter is eligible to vote in a different precinct, an eighteenth code segment for identifying that the voter is only eligible to vote provisionally, a nineteenth code segment for identifying that the voter is not eligible to vote in this election, a twentieth code segment for providing a menu screen with selectable election help topics, a twenty-first code segment for providing help information on an election help topic selected from the menu screen, and a twenty-second code segment for displaying an integrated video on an election help topic selected from the menu screen.

The present invention is further directed to methods of providing decision support program control on an electronic device with a display, with the electronic device having access to available data. The main method includes the steps of providing a menu of selectable choices on the display, selecting one of the choices in the menu, looking up a step associated with the selected choice in a step table, determining the step type from the step table, displaying nothing on the display if the determined step type is a decision step and determining the next step based upon user input and the available data, displaying a list of actions on the display if the determined step type is an action step and determining the next step based upon user input, providing a step 1D and returning to the menu if the step 1D is zero or determining the next step type from the step table if the step 1D is not zero. The method may include the additional steps of displaying a voter lookup screen on the display if the determined step type is a voter lookup step, determining if the user found a voter in the voter lookup step, and returning to the menu if the step 1D is zero or determining the next step type from the step table if the step 1D is not zero. Preferably, the method provides a broadened voter lookup step if the user input is that none of the voters identified in the voter lookup step is the desired voter. Further method steps may include displaying an address lookup screen on the display if the determined step type is an address lookup step, determining if the user found an address in the address lookup step; and returning to the menu if the step 1D is zero or determining the next step type from the step table if the step 1D is not zero. An additional step may include providing a broadened address lookup step if the user input is that none of the addresses identified in the address lookup step is the desired address. Further methods include the steps of displaying text on the display if the determined step type is a Yes, No or Unsure step, providing selections on the display for Yes, No or Unsure entries by the user, looking up the next step based upon entry by the user of Yes, No or Unsure, and returning to the menu if the step 1D is zero or determining the next step type from the step table if the step 1D is not zero.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1A is a perspective view of a typical laptop or portable computer which may utilize the software and practice the methods of the present invention;

FIG. 1B is a plan view of a typical Pocket PC which may utilize the software and practice the methods of the present invention;

FIG. 1C is a plan view of a typical compact disk (CD) which may contain the software of the present invention;

FIG. 1D is a plan view of a typical compact flash card which may contain the software of the present invention;

FIG. 2A is a screen which may appear on the computer shown in FIG. 1A or the PDA shown in FIG. 1B which identifies logo of the software program during start up;

FIG. 2B is a screen which may also appear during start up and which provides more information about the program;

FIG. 3 is a typical user interface screen for confirming the election, the election date and related information;

FIG. 4 is a typical user interface screen which provides for selection of the proper precinct for the election of FIG. 3;

FIG. 5 is a typical main menu screen for selecting the desired voter election decision process;

FIG. 6 is a typical screen for responding to a question posed during the election decision process;

FIG. 7A is a typical voter lookup screen;

FIG. 7B is a typical screen of a result list from conducting a search on the voter lookup screen in FIG. 7A;

FIG. 7C is a typical screen of a result list from conducting a broadened search on the voter lookup screen in FIG. 7A;

FIG. 7D is a typical detail screen for a selected voter from the results list in FIG. 7B;

FIG. 7E is a typical screen with the particular polling place detail;

FIG. 8 is a typical screen for responding to a question posed during the election decision process;

FIG. 9 is a typical screen for responding to a question posed during the election decision process;

FIG. 10 is a typical screen for responding to a question posed during the election decision process;

FIG. 11 is a typical screen for responding to a question posed during the election decision process;

FIG. 12 is a typical screen for responding to a correct address inquiry for a preprinted application;

FIG. 13 is a typical screen for responding to a when did you move inquiry;

FIG. 14 is a typical screen for responding to a legal name inquiry;

FIG. 15 is a typical address lookup screen to determine a voter's correct voting location;

FIG. 16 is a typical screen with results from the address lookup search in FIG. 15;

FIG. 17 is a typical screen with results from a broadened address lookup search;

FIG. 18 is a typical screen which provides further detail about a selected voter in the lookup results list shown in FIG. 17;

FIG. 19 is a typical action screen that identifies that the voter is only eligible to vote provisionally;

FIG. 20 is a typical action screen that identifies that the voter is eligible to vote in a different precinct as a result of the voter eligibility interview process;

FIG. 21 is a typical action screen that identifies that the voter is not eligible to vote in this election;

FIG. 22 is a typical explanation screen that may explain additional information or additional action needed;

FIG. 23 is a typical screen for selecting the primary language while assisting the voter;

FIG. 24 is a typical menu screen for providing further help information on a selectable topic;

FIG. 25 is a typical submenu screen for providing further help information on one of the topics selected from the menu on the screen in FIG. 24;

FIG. 26 is a typical screen for searching for further help information by an entered keyword;

FIG. 27A is a typical screen for displaying the results of a help searcy;

FIG. 27B is a typical screen for displaying a detailed help topic;

FIG. 27C is a typical screen for displaying an integrated video on a selected election topic;

FIGS. 28A to 28P collectively constitute An exemplary flowchart of the election logic provided by the software of the present invention that guides the pollworker to the correct voter eligibility result for a particular voter; and

FIG. 29 is a flow chart of the logic provided by the software of the present invention for the decision support process.

### DESCRIPTION OF THE PREFERRED EMBODIMENTS

It will be understood that the present invention may be embodied in other specific forms without departing from the spirit thereof. The present examples and embodiments, therefore, are to be considered in all respects as illustrative and not restrictive, and the invention is not to be limited to the details presented herein.

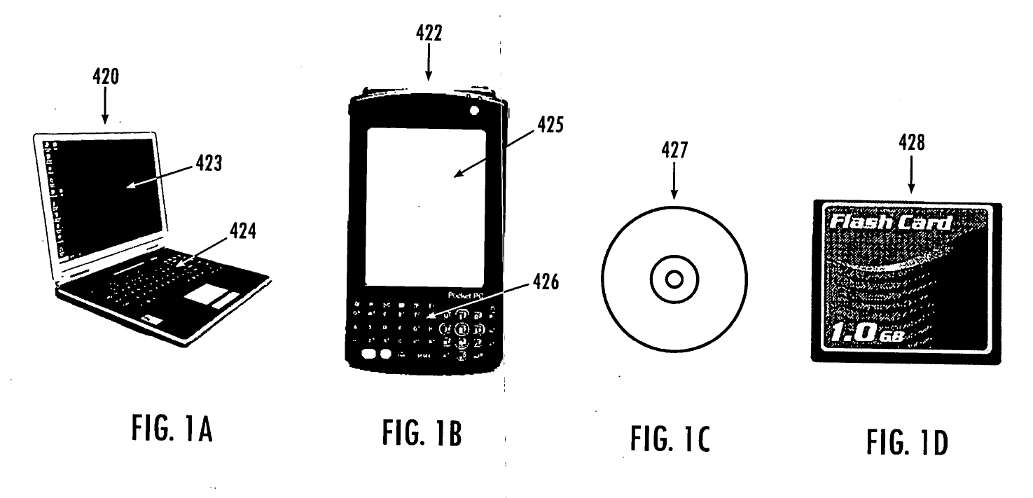

The present invention provides methods and software, such as on a portable computer 420 in FIG. 1A, a personal digital assistant (PDA) (not shown) or a Pocket PC 422 in FIG. 1B, typically within the polling place, to provide election decision support to the pollworker so tnat the pollworker can always correctly determine each voter's eligibility and also be guided in the correct procedures for that voter, whether that means directing the voter to another polling place or completing appropriate forms. Portable computer 420 has a screen 423 for displaying visual information and a keyboard 424 for entering information or responses requested. Similarly, Pocket PC 422 has a screen 425 for displaying visual information and a keyboard 426 for entering information or responses requested. In addition, screens 423 and 425 may have touch sensitive fields for entering information or for responding to inquiries.

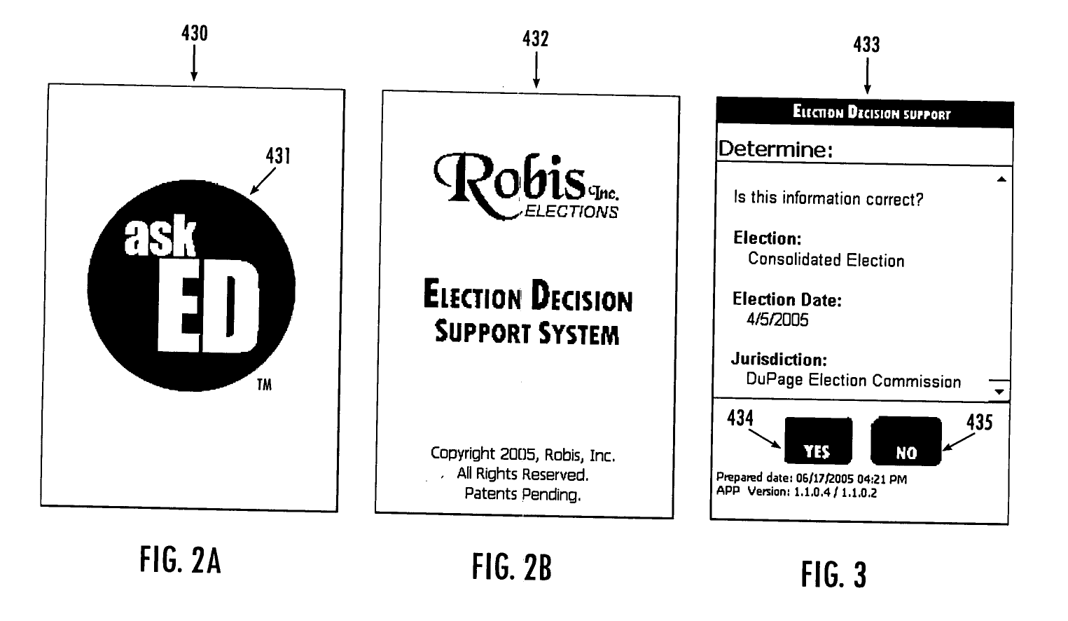

Portable computer 420 and Pocket PC 422 are preferably preprogrammed with the election decision software of the present invention, which may be on a CD 427, shown in FIG. 1C, or on a compact flash card 428 shown in FIG. 1D, or which may be downloaded from other computers, from an internet site, or the like, to the portable computer 420 or to the Pocket PC 422, to provide election decision support to the pollworker so that the pollworker can always correctly determine each voter's eligibility and also be guided in the correct procedures for that voter, whether that means directing the voter to another polling place or completing appropriate forms. When preprogrammed with the software of the present invention, computer 420 and Pocket PC 422 may provide the exemplary screens shown in FIGS. 2A through 27 while navigating through the election decision support methods of the present invention. For example, computer 420 or Pocket PC 422 is preferably pre-programmed with all of the election logic, voter information, addresses, ballot styles, precincts, and related information for the particular election. Alternatively, the electronic device may be in communication with a remote database that contains the voter information, addresses, ballot styles and precincts for the particular election.

To determine the eligibility for a particular voter, the pollworker asks and receives answers to a series of questions. A screen, many of which are user interactive, as seen in FIGS. 2A-27, is presented on the electronic device for each question and the software automatically directs the pollworker to the next correct screen based on his or her inputs/answers. The answer to each question determines the next question asked, so that the pollworker is guided to the exact correct answer/procedure for the particular voter with the minimum number of questions. Where necessary in the process and as directed by the questions, the pollworker can lookup an address or voter record from a pre-supplied list or database. Some questions are directed to the pollworker, such as “Is there a preprinted application for the voter.” And some questions are for the pollworker to ask the voter, such as “When did you move from the address printed on your application?”

When a question is directed to the voter, the software can also speak the question in any of a variety of languages through an audio speaker. This feature increases communication with the voter, reduces stress in the polling place and again allows the pollworker to determine the correct eligibility for the voter and to more accurately communicate to the voter any actions or decisions the voter needs to make, such as traveling to another polling place where he or she is eligible to vote a full ballot.

At the conclusion of the question interview, the software presents the pollworker with the correct actions for the voter, the correct ballot style, any forms that need to be completed and any procedures that need to be followed by the pollworker to ensure that the ballot will be counted.

In addition to problems of voter eligibility, this invention can be used to solve other election issues such as problems encountered during close of polls, resolving election equipment problems, assisting voters with disabilities, and the like.

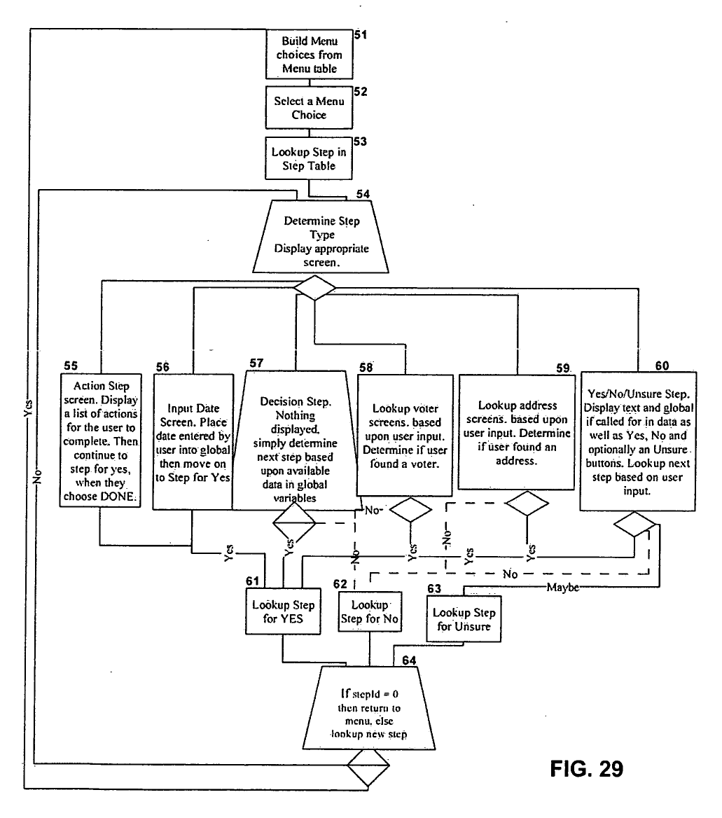

The present invention includes both a method for determining voter eligibility, and software that provides the decision support capabilities. This software follows a unique path of questions (STEPS) based on the answer to previous questions or on information from the databases contained on the device. For further information, see the discussion below for FIG. 29.

Prior to an election, jurisdiction-specific data including a voter list, address list, precinct list and ballot styles for each address are loaded into a database for use on the device during the particular election.

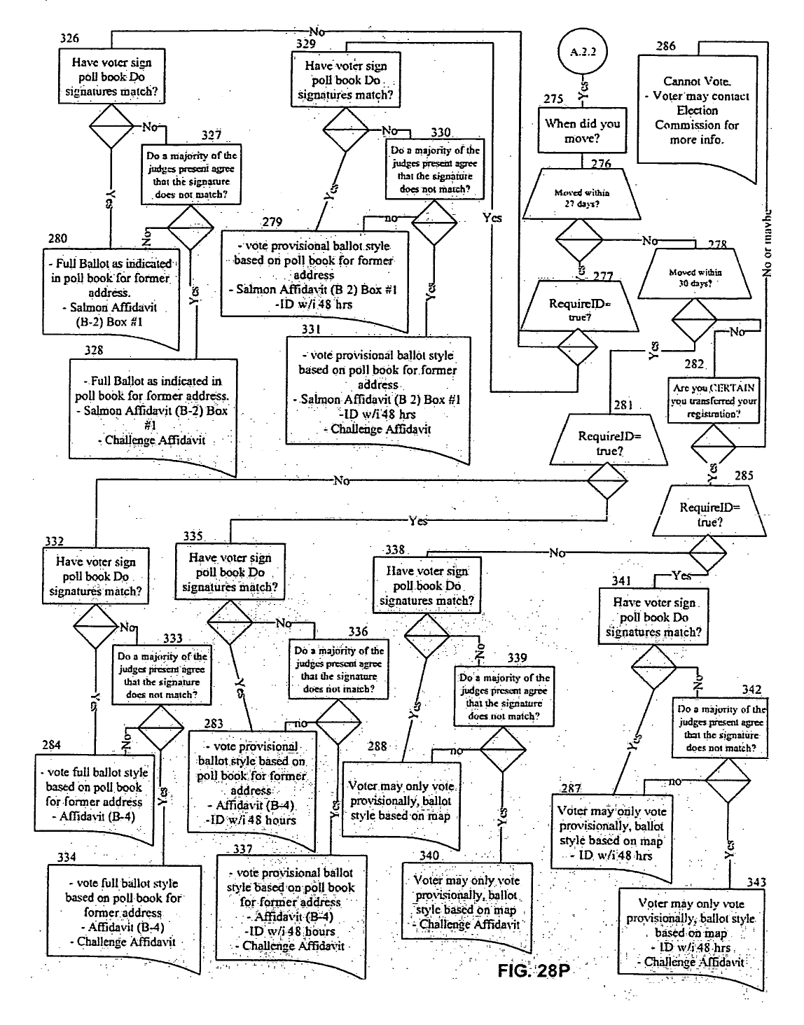

The election logic for the particular State and the particular election type (for example, primary, local, federal, etc.) is programmed into the database as a series of steps. For further information, see the discussion below for FIGS. 28A-28P.

Each step includes the step type, text and audio to present to the pollworker and voter, and the next steps based on the answer to the current step (question).

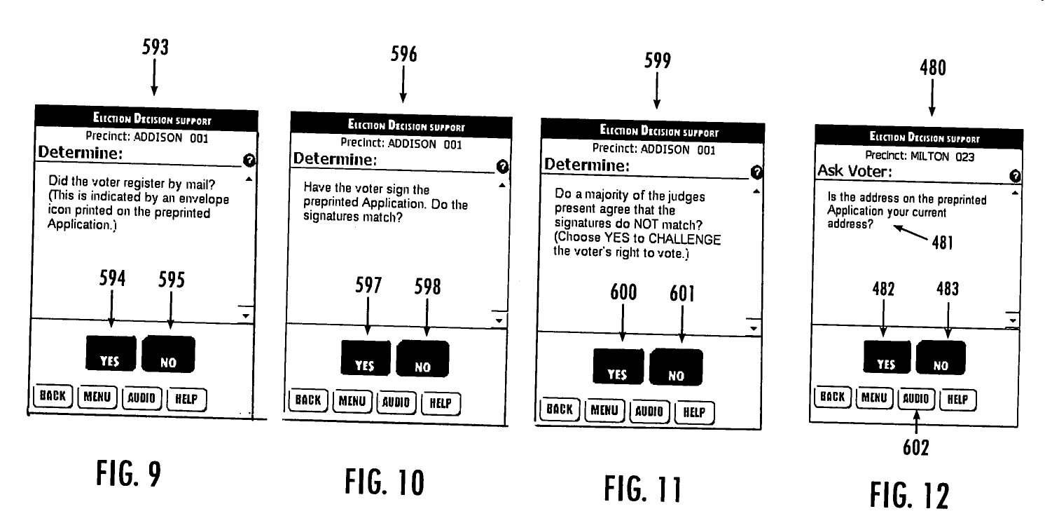

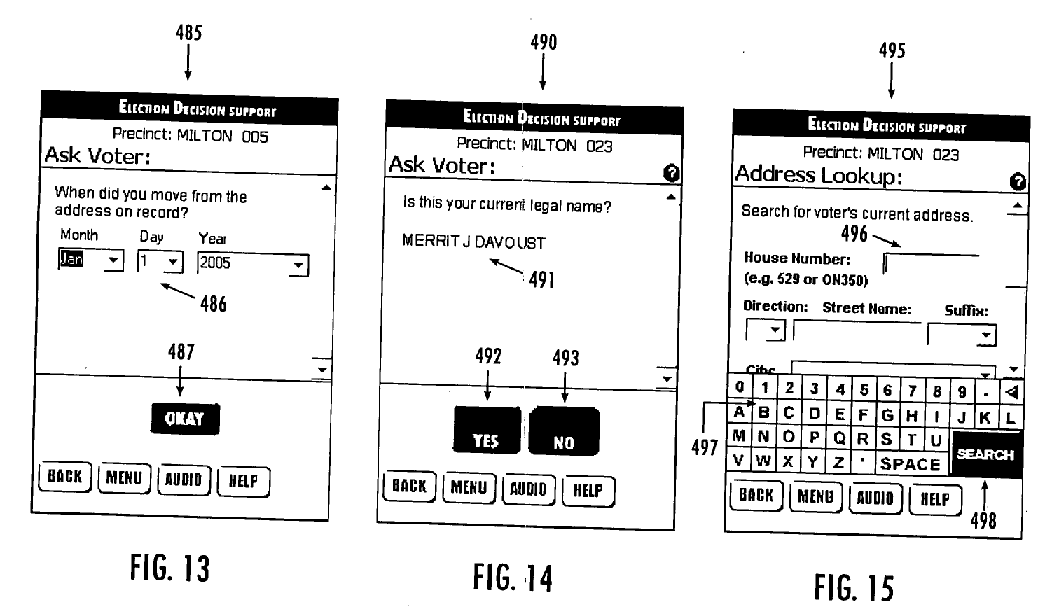

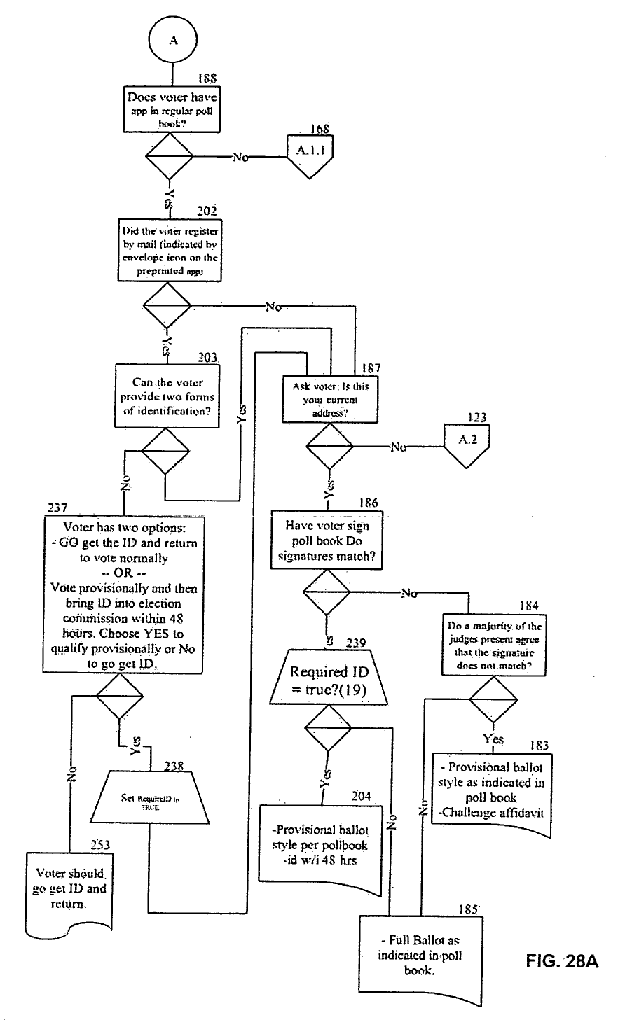

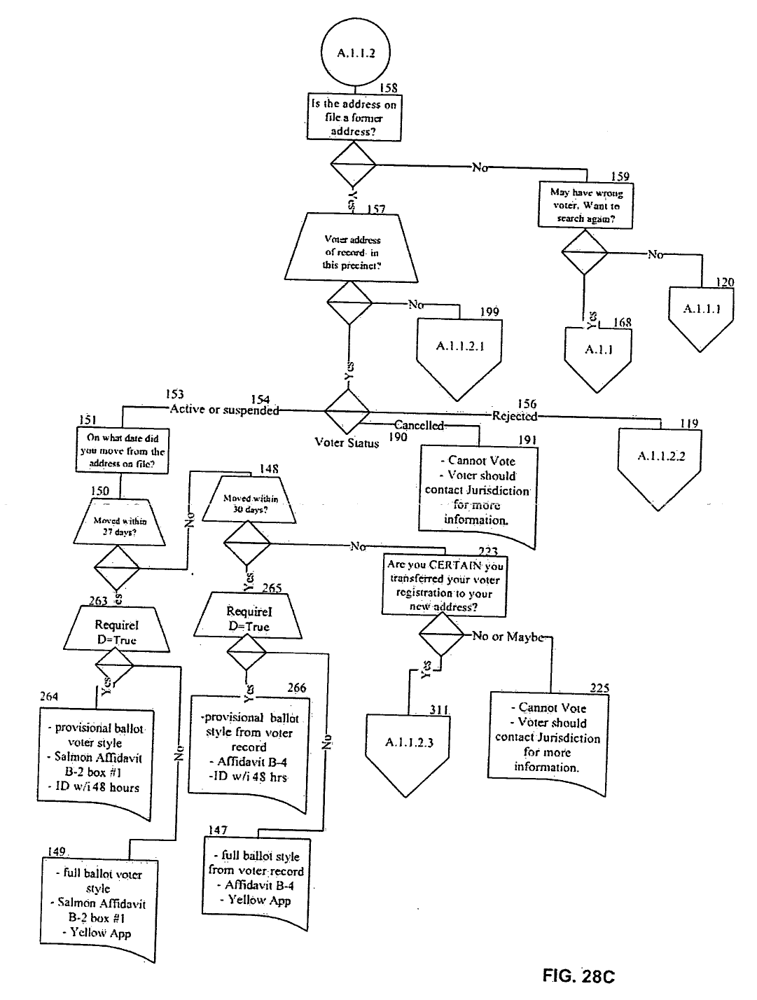

Step types may include yes/no/maybe questions as seen in FIG. 6, address lookup as seen in FIGS. 15-18, voter lookup as seen in FIGS. 7A-7E, date entry as seen in FIG. 13, and decision steps as seen in FIG. 29. Decision steps are steps that do not appear to the pollworker, but instead provide the ability for the program to branch to other steps based on database or other entered criteria. For example, if a voter is asked when he or she moved from a previous address, the next step might be a decision step that determines if the voter moved within 30 days of the election or not and branches to two different steps, accordingly.

If the logic requires the pollworker to lookup a voter or an address from the databases that are pre-programmed onto the device, an input screen such as seen in FIGS. 7A-7D and 15-18, will appear requesting appropriate information such as first name, last name and date-of-birth for a voter lookup. Depending on the jurisdiction, social security number, driver's license and voter ID number can also be used for voter lookup. The software will then perform an “auto-broadening,” which means that it will try searching on all of the fields provided, but if no records are found, will gradually broaden the search until records are returned. For example, if a search is done on first name of “David”, last name of “Davoust”, and date-of-birth of “Jan. 1, 1980”, the software will first look for a voter that matches all of that information. If no records are found, it will drop the first name and look for any voters matching the last name and date-of-birth, and so on. The software will also inform the pollworker if it found an exact match or if the matches are just the closest ones found. This auto-broadening helps pollworkers to locate voter records when there may be a spelling difference or other data entry problem.

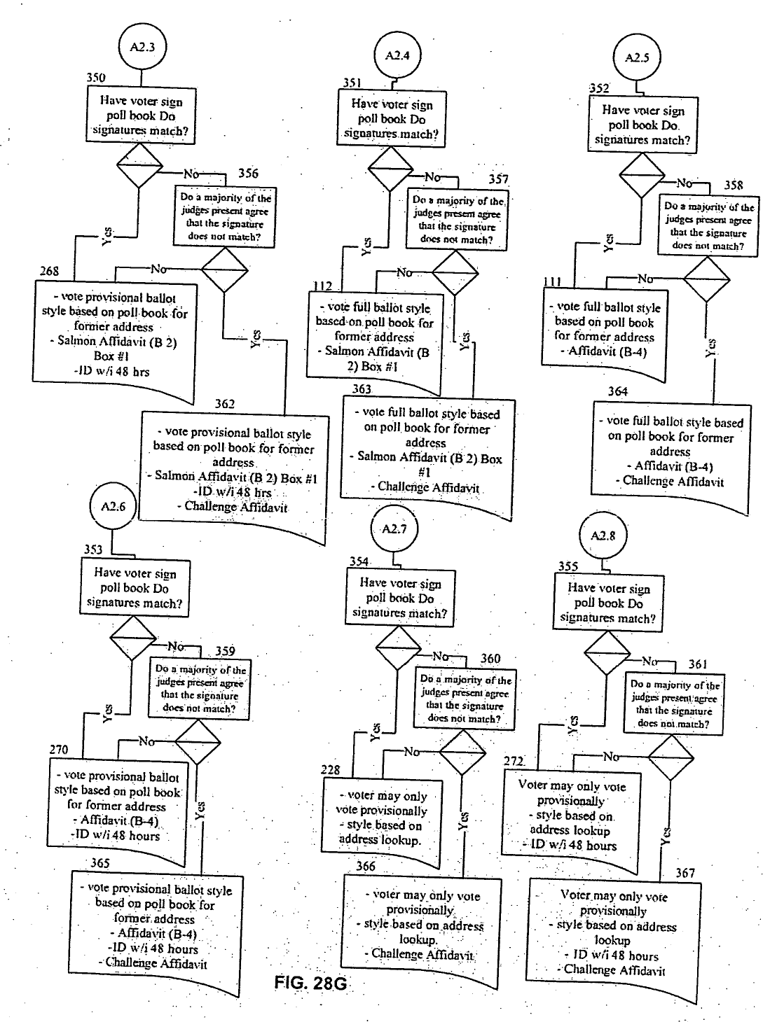

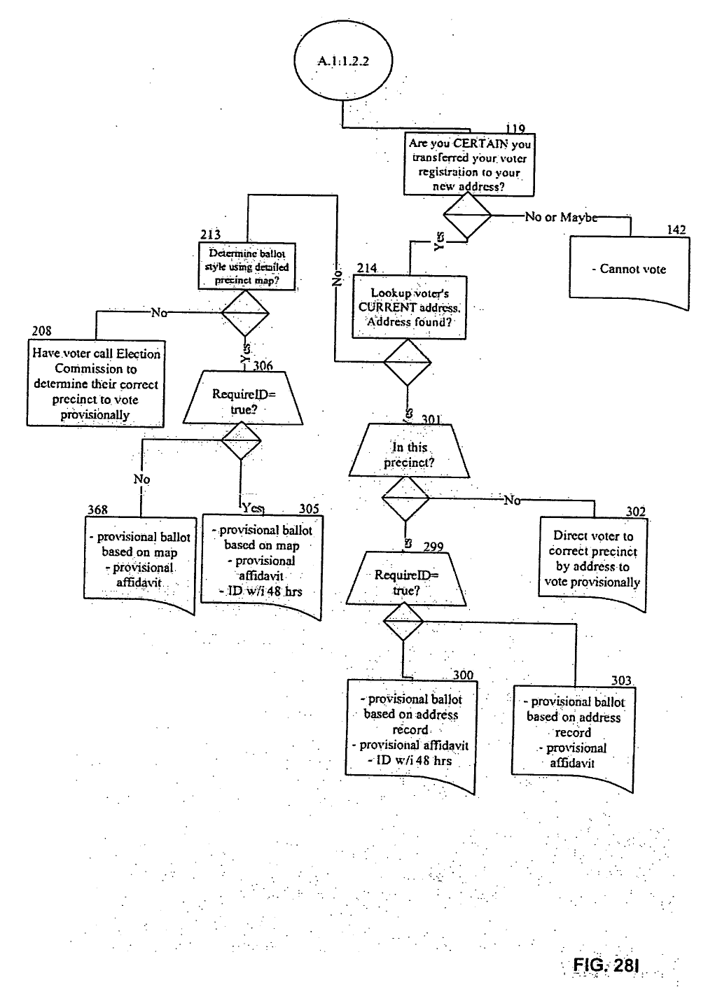

When a voter's eligibility as been determined by the software, an action step is presented (FIGS. 19 and 21). This is a special type of step that lists a series of actions. Actions might be instructions to the pollworker, a redirection to another polling place, a form that needs to be filled out, or the like.

At any point during the interview process, the pollworker can backup to a previous step if he or she determined that a wrong selection was made. The pollworker can also terminate the interview process at any time by clicking a button to jump back to the menu.

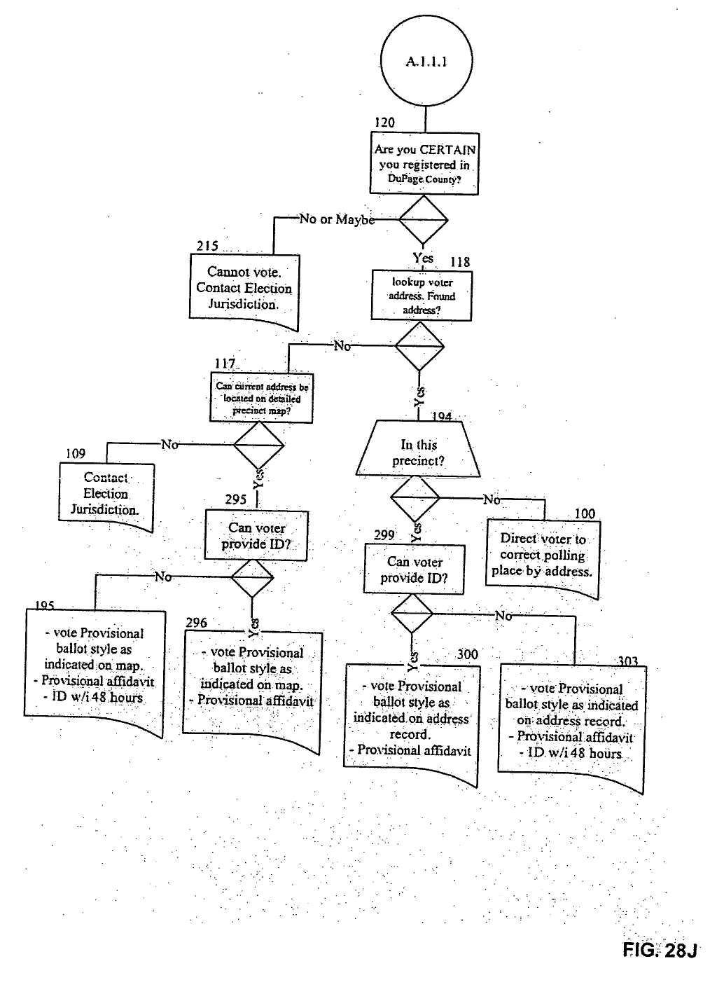

At any step, a question mark will appear on the screen if additional explanatory information is available for that question explaining the reasoning behind a particular question. For example, see FIG. 22.

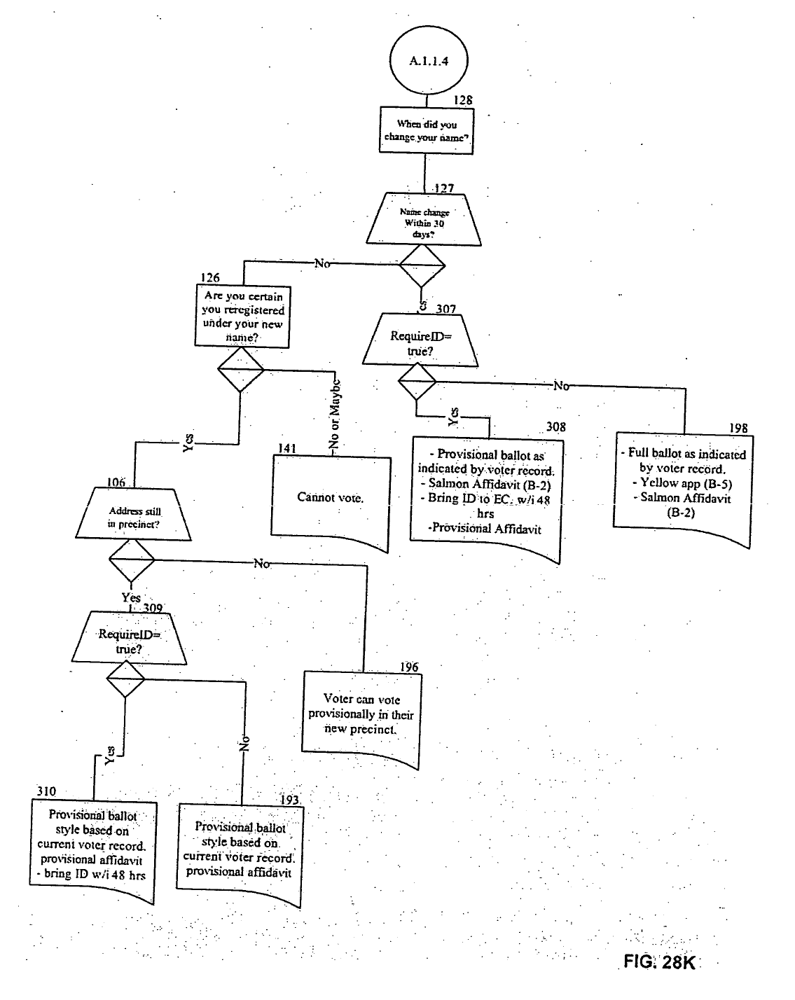

At any step that provides either a question for a voter, an explanation for a voter, or an action step which display's the results of the interview, the pollworker may press a button to play an audio version of the information through the device's speaker in any of a number of pre-programmed languages so that any voter whose primary language is not English can better understand the process, such as shown in FIG. 23.

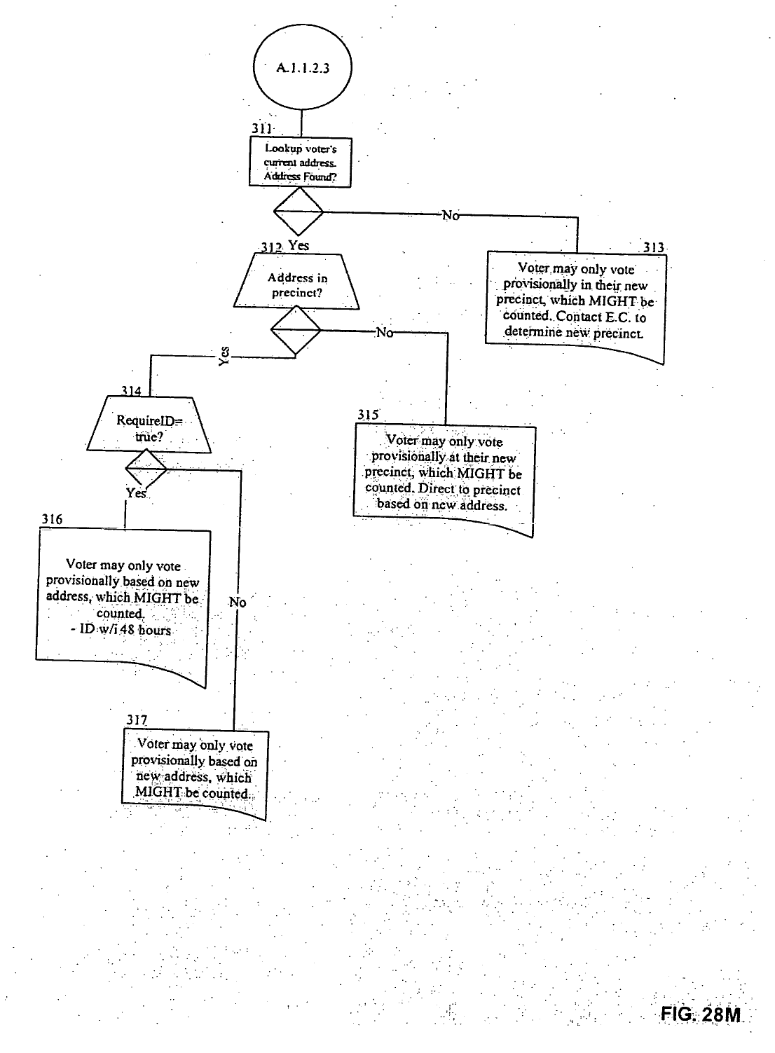

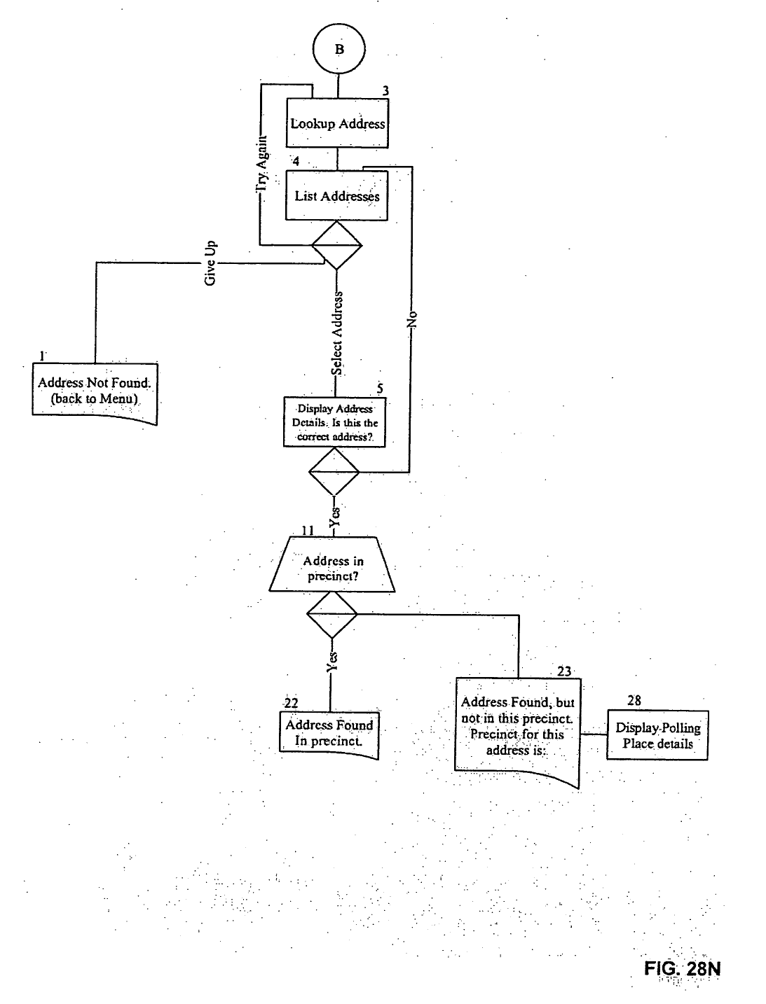

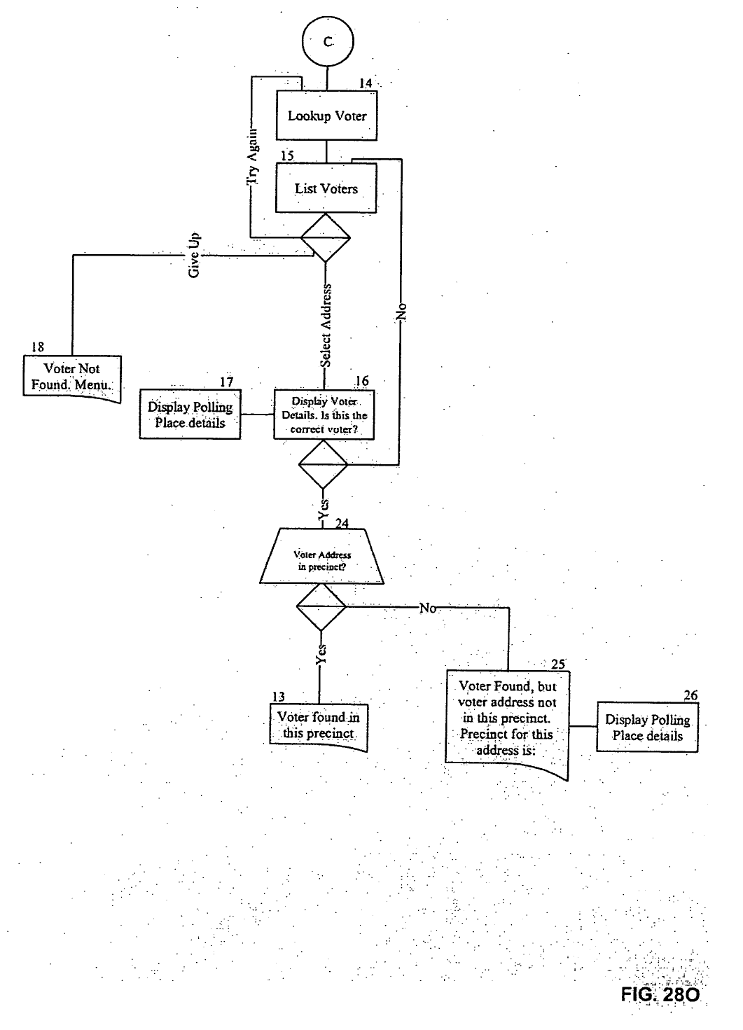

For issues other than voter eligibility, the invention also consists of a help database with election-related topics as shown in FIG. 25, a search system as shown in FIG. 26, search results screens as shown in FIG. 27A, detailed help topic screens as shown in FIG. 27B, and integrated multimedia/video as shown in FIG. 27C. The pollworker can browse or search on help topics. Each topic can provide text explanation and/or links to other topics. In addition, any topic can link to a relevant full-motion video. Help topics can also be linked to decision support steps such as the voter eligibility steps. Help information can be stored on the portable device or can be transparently accessible via a modem, Internet or network connection. This just-in-time election information makes it possible for an election pollworker to handle the new election equipment, changes in voting laws and the special situations presented by voters so that each eligible voter has the opportunity to vote a correct ballot that will be counted.

When the program is started, after running data and security checks, a list of menu choices are displayed to the user. Each menu item contains a step number. When a menu item is chosen, the program looks up the step information.

Each step contains the following information: a Step number, which is used to reference the specific step and a Screen type, which determines how the program interprets, displays and acts upon a step.

A decision step type is one that makes some kind of internal calculation or determination and then branches to one of two different step choices, such as Step for Yes or Step for No, based upon the outcome of that calculation. The resulting test will always be either true or false. For example, a decision step might test if the entered date is within 30 days of the election date or not. A true condition would cause the program to branch to the Step for Yes; a false condition would cause the program to branch to the Step for No.

A Yes/No/Unsure screen type displays the appropriate information on screen and displays a button for Yes, a button for No and optionally a button for Unsure if there is a Step for Unsure indicated on the record.

A Lookup Address screen type displays the address input screen and enters the address lookup process. If the pollworker locates the appropriate address, then the address is stored in global variables, and the Step for Yes is loaded. If the pollworker cannot find the address and chooses “Give Up,” then the Step for No is loaded.

A Lookup Voter screen type displays the voter input screen and enters the voter lookup process. If the pollworker locates the appropriate voter, then the voter information is stored in global variables and the Step for Yes is loaded. If the pollworker cannot find the voter and chooses “Give Up,” then the Step for No is loaded.

A Name Change Date screen type displays a date input screen and stores the entered data into a global variable. An okay button is displayed, and when pressed, causes the Step for Yes to be loaded.

A Move Date screen type displays a date input screen and stores the entered data into a global variable. An okay button is displayed, and when pressed, causes the Step for Yes to be loaded.

An Action step screen displays a list of actions that the voter or pollworker need to take. A Done button is displayed. Pressing this button goes to the Step for Yes.

A Menu step displays the menu and clears out all of the global variables. The following fields are representative of the types of information that may be employed for each step. Headline: this displays on the top of the screen. Question text: this is the main body of text that appears on the screen. It is the question text. Explanation text: this is optional. If there is text in this field, then a button appears on the step screen that allows the pollworker to display an explanation pop-up screen which displays this text. Global Variable display: these fields determine if a global variable should also be displayed on the screen. For example, the question might be, “Is this your current address?” and then this field will cause the screen to also display the voter's address that is stored in the global variable. Step for Yes: this is the ID of the step to be loaded based upon user input. See step screen types above. Step for No: this is the ID of the step to be loaded based upon user input. See step screen types above. Step for Unsure: this is the ID of the step to be loaded based upon user input. See step screen types above. Link to actions for action steps. Link to audio/text-to-speech for audio speaking of the question text and actions.

Once an interview is started, each step leads to another step based on the pollworker inputs. This continues until the interview ends in an action step that leads to the menu or the pollworker aborts the interview by selecting the Menu button.

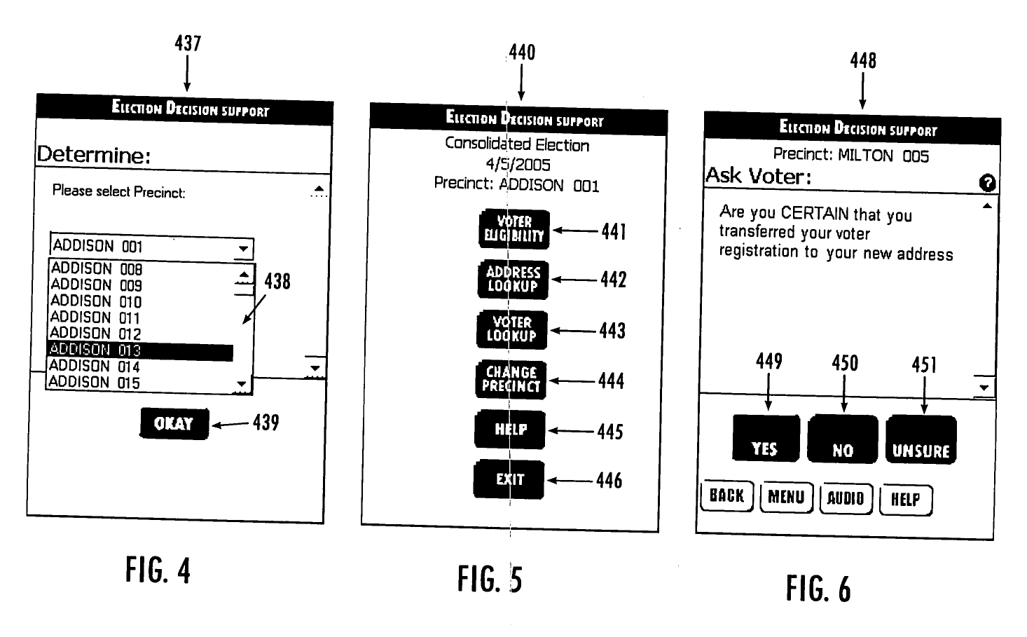

With the foregoing general background in mind, some specific examples will be considered. When the program of the present invention is initiated, such as on laptop computer 420 or Pocket PC 422, an initial screen 430 in FIG. 2A may appear which displays a trademark or logo 431 associated with the program. The next screen 432 in FIG. 2B may display additional informational items such as the source of the program, the name of the program and legal information, such as a copyright notice. Shown in FIG. 3 is the next screen 433, which displays information about the subject election, such as the type of election, the election date and the jurisdiction of the election. Screen 433 then prompts the user to indicate whether the displayed information is correct, such as by activating the YES field 434 or the NO field 435.

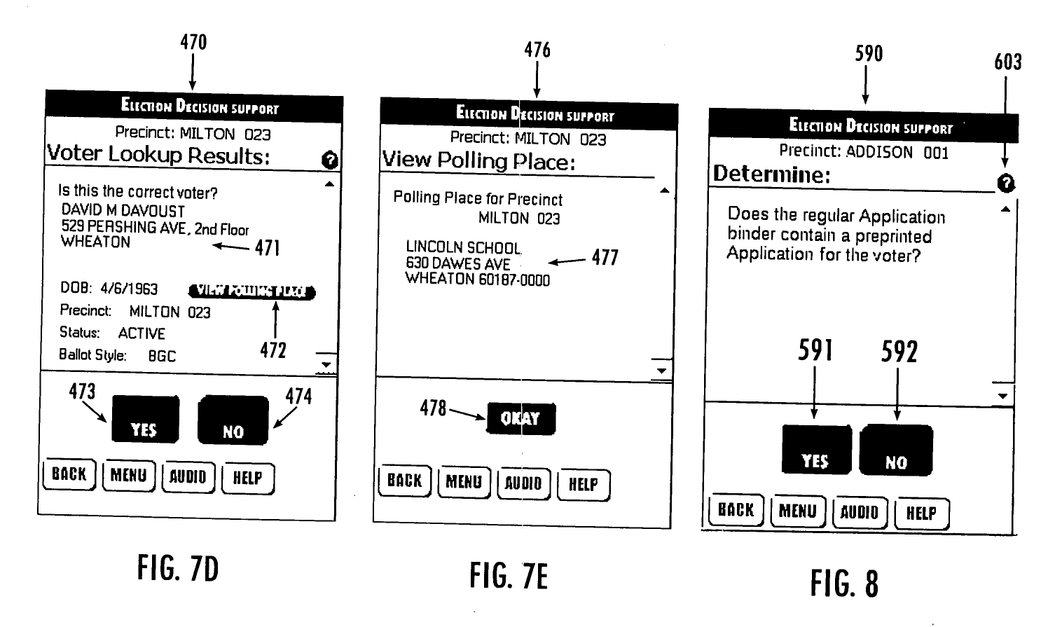

If the election is confirmed as correct in FIG. 3, the user will be requested to enter an applicable precinct in screen 437, such as by scrolling down through a field 438 containing a plurality of precincts, selecting the desired precinct and activating an OKAY field 439. After completing this precinct information, the user may be presented with the menu screen 440 of FIG. 5. The user can select from a plurality of voter topics, such as Voter Eligibility 441, Address Lookup 442, Voter Lookup 443, Change Precinct 444, Help 445 and Exit 446.

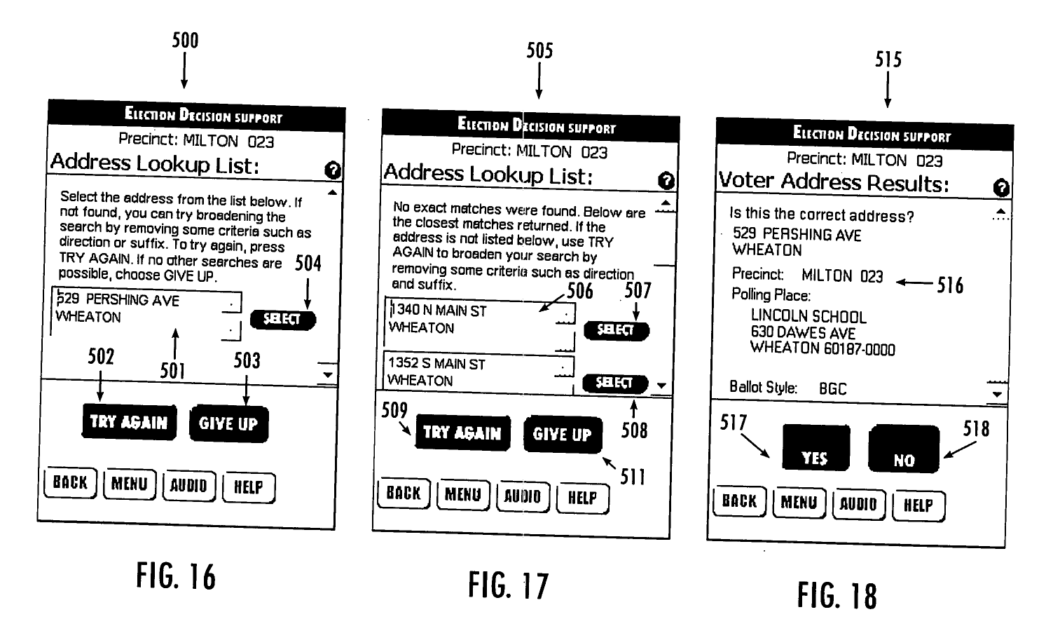

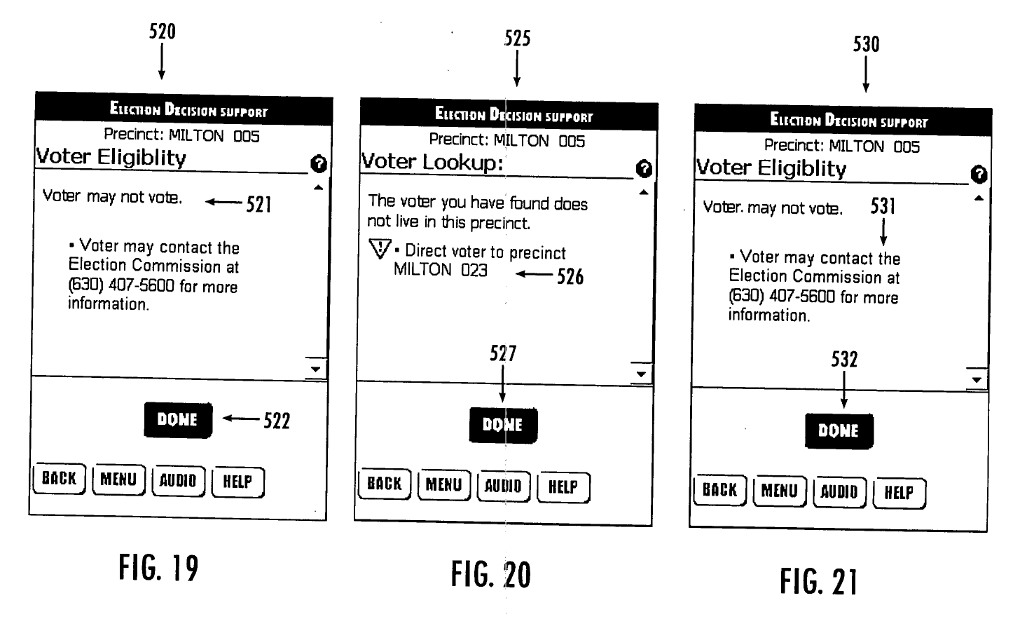

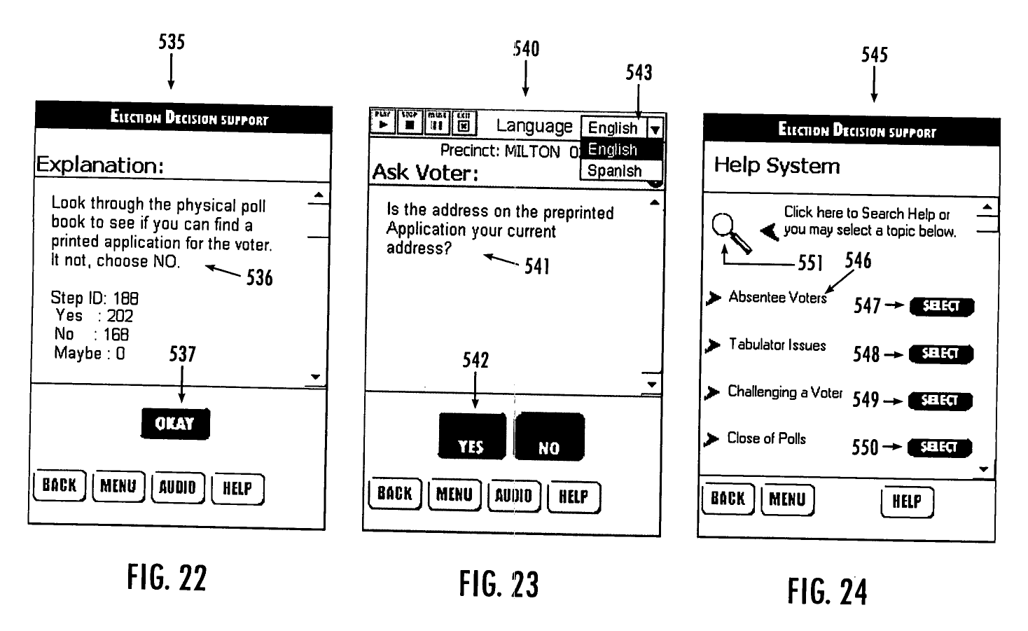

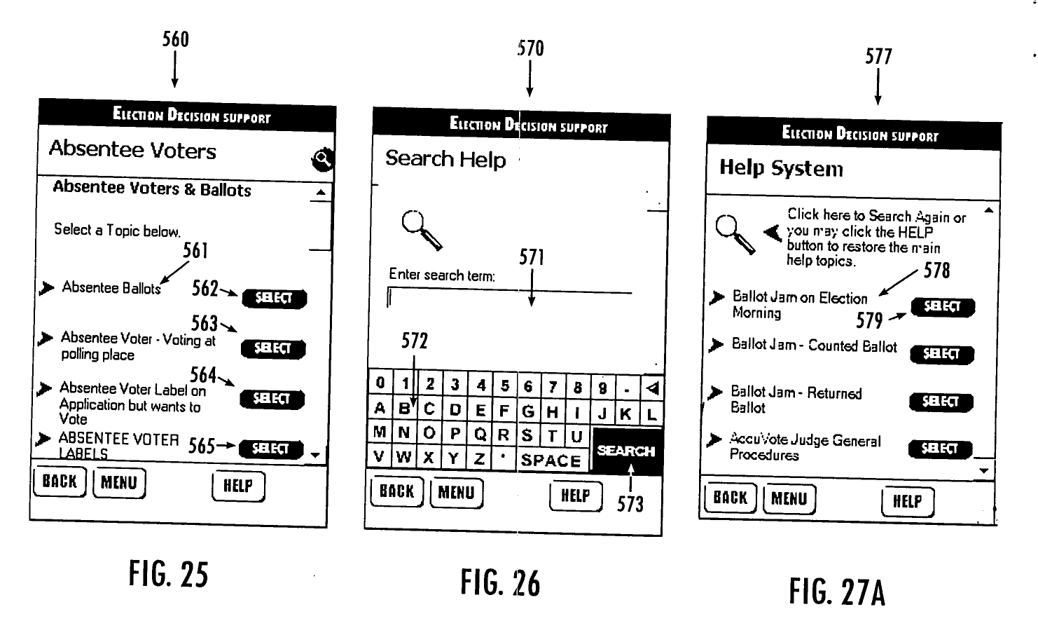

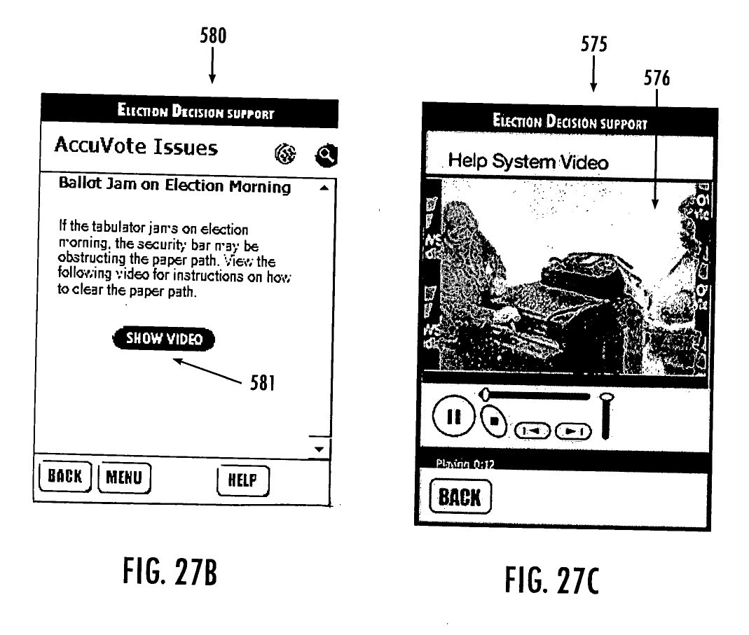

Activation of the voter eligibility field 441 in FIG. 5 will initiate the voter eligibility decision support process. The user will be presented with a question such as the one shown on screen 590 in FIG. 8. For this example, the user would look in the Application binder to determine if the voter's name is listed. The user can also activate the question-mark button 590 in FIG. 8, which may cause the explanation screen 535 in FIG. 2 to appear and to provide detailed instructions for the user. Choosing OKAY button 537 in FIG. 22 returns screen 590 in FIG. 8. Choosing YES button 591 may cause screen 593 in FIG. 9 to appear. This screen presents a question “Did the voter register by mail?” Selecting the NO button 595 may cause the screen 480 in FIG. 12 to appear. This screen says “Ask voter” at the top of the screen and gives a question to ask the voter. If English is not the voter's primary language, the user can activate the AUDIO button 602 in FIG. 10. The audio control panel 543 in FIG. 23 may then appear. The user can select a language and press Play to have the question read in the selected language throught the device's speaker to aid in communicating with the voter. Pressing the YES button 542 in FIG. 23 may cause the screen 596 in FIG. 10 to appear, which directs the user to have the voter sign the application and to ask the user if the signatures match. If the signatures do not match, then the user may activate the NO button 598 in FIG. 10, which may cause screen 599 in FIG. 11 to appear. This question provides the user with instructions on what to do with the unmatched signatures. If the judges agree that the signatures do not match, the user selects the YES button 600 which may cause screen 520 in FIG. 19 to appear. Screen 520 displays the voter eligibility determination results of the foregoing series of election decision support questions. Field 521 informs that the voter may only vote provisionally, and includes a list of actions to be taken by the user to ensure that the voter's ballot will be counted. After performing the listed actions, the user activates the DONE button 522 in FIG. 19 to return to the MENU screen in FIG. 5.

Activation of voter lookup field 443 in FIG. 5 will initiate the voter lookup function shown in FIGS. 7A-7D. Screen 453 in FIG. 7A provides the option of entering one or more of the following fields: a last name in field 455, a date of birth in field 456, and/or a first name in field 454. The user may utilize a simulated keyboard 457 to enter the requested information. When the information is entered, a search field 458 is activated to initiate the search.

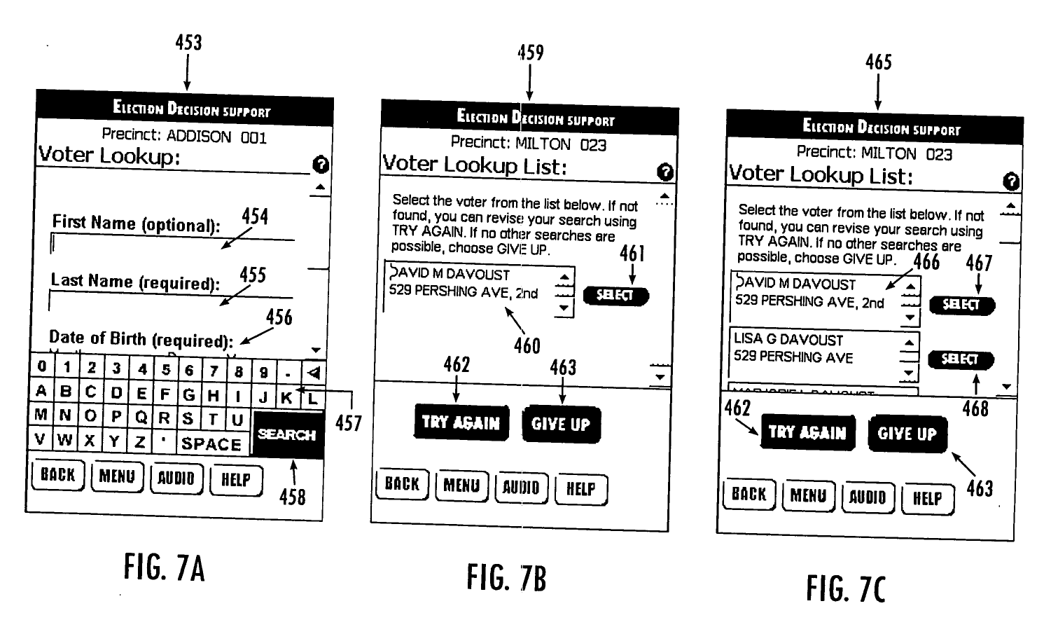

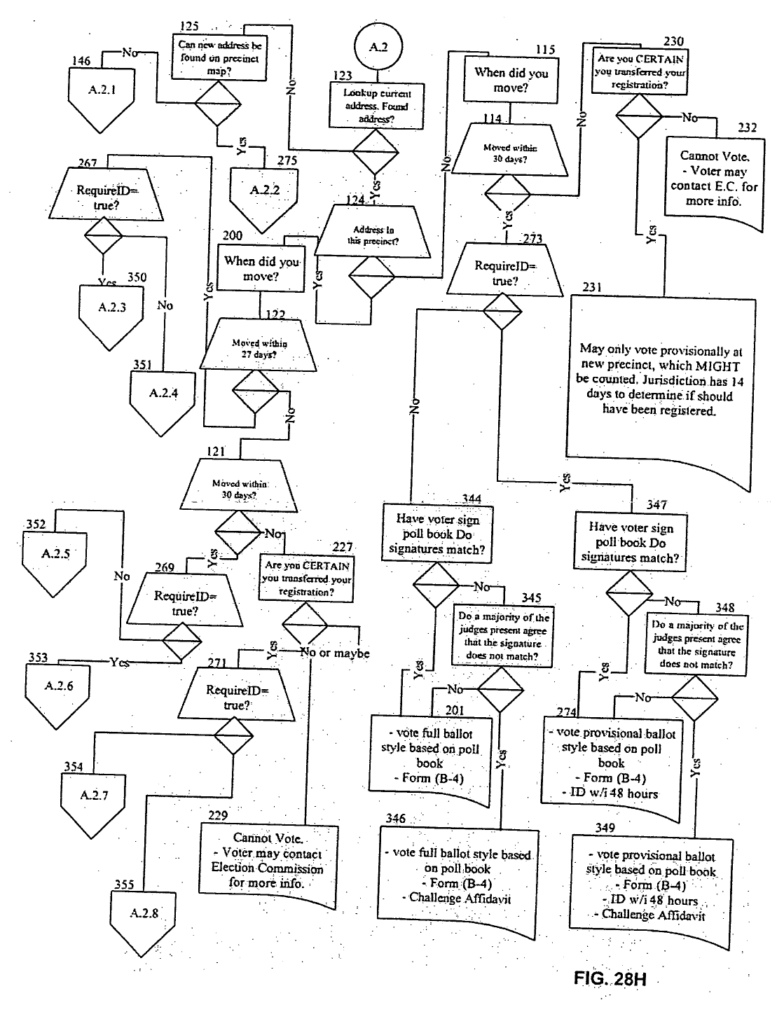

The results of the voter lookup search are shown in a field 460 on screen 459 in FIG. 8. The user may select the voter displayed in field 460 by activating the Select field 461. Alternatively, the user may choose to Try Again by activating field 462 or Give UP by activating field 463. Screen 465 in FIG. 7C is similar to Screen 459 in FIG. 7B, except that the voter lookup search has identified more than one voter in field 466. In this instance, a separate Select field 467 or 468 is provided for each identified voter. The user then selects the applicable voter by activating the appropriate Select field 467 or 468. After selecting the desired voter, screen 470 in FIG. 7D may appear, showing further information about the voter in field 471. Since the identified precinct is different than the one originally entered in screen 437 (FIG. 4), a View Polling Place field 437 may appear. If field 437 is activated, screen 476 may display the correct polling place for the voter in field 477. Thus, an errant voter is quickly routed to a correct polling place. Activating Okay field 478 may return the user to the further information screen 470 in FIG. 7D. Choosing the YES button 473 in FIG. 7D may display the correct actions for the user to take for this voter as displayed in field 525 in FIG. 20. Activating the DONE button 527 in FIG. 20 may return the user to the menu of screen 440 in FIG. 5.

Activation of Address Lookup field 442 in FIG. 5 may result in a series of screens, such as the examples shown in FIGS. 15-18. Address information can be entered in field 496 of FIG. 15 by means of a simulated keyboard 497. The address lookup search is then initiated by activating the search field 498.

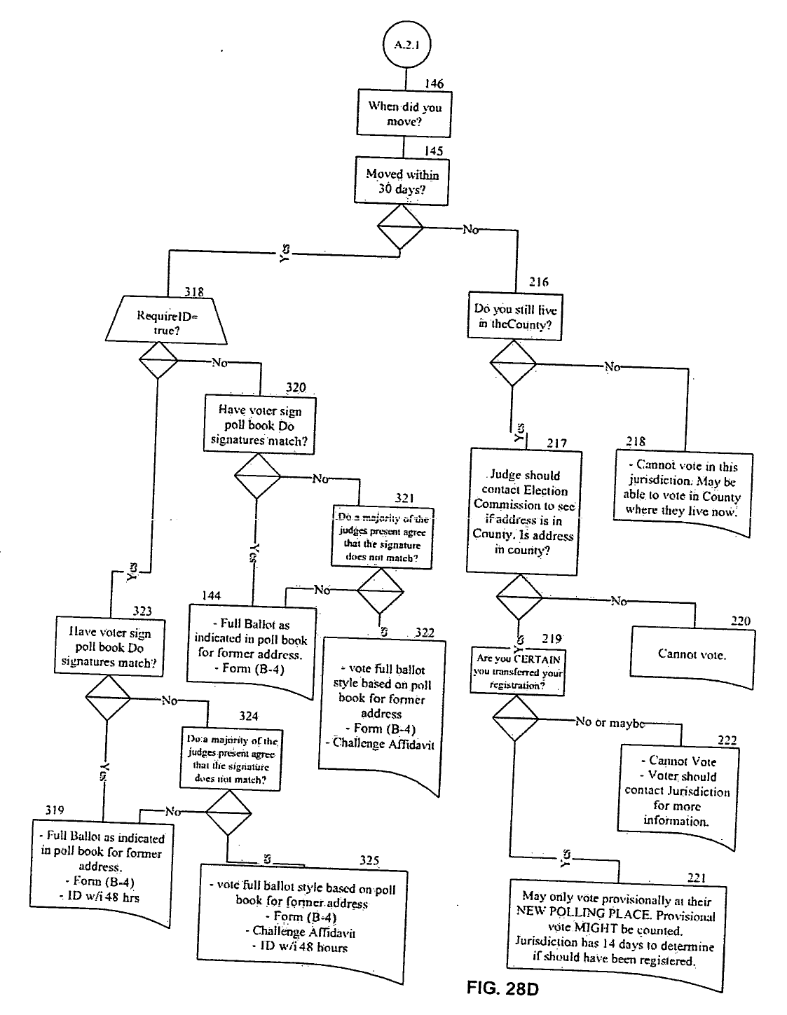

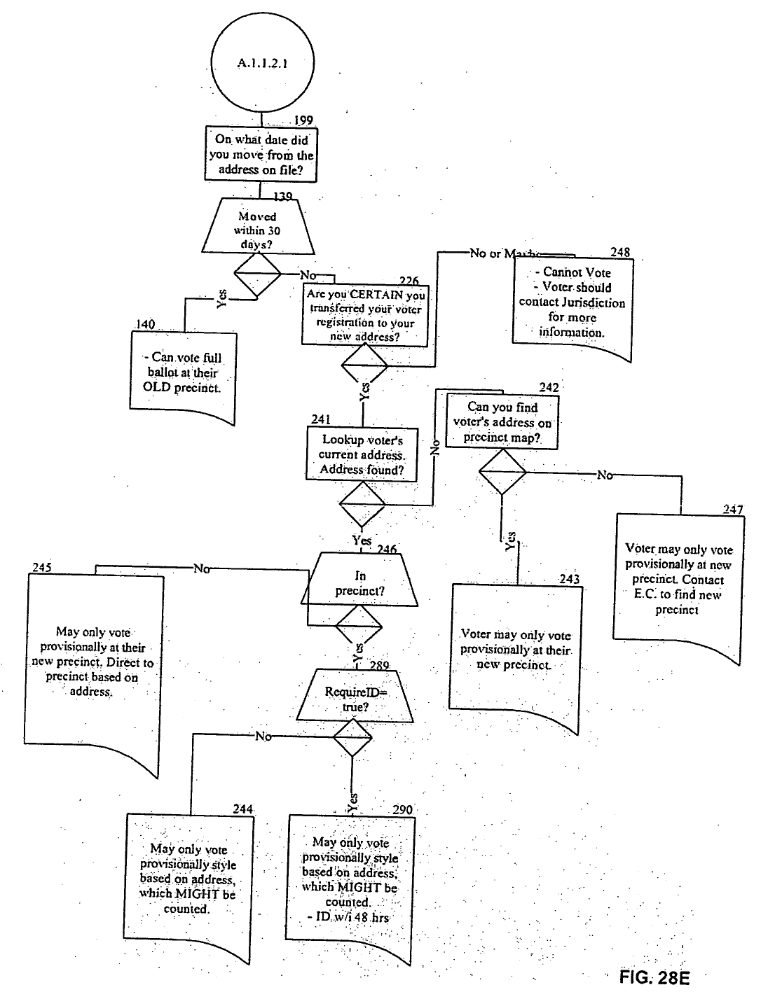

The address lookup search appears on screen 500 in FIG. 16. A field 501 has a single address which may be selected by activating Select field 504. Screen 505 in FIG. 17 is similar to screen 500 in FIG. 16, except that the address look up search has been broadened beyond the entered information to return more than one address. This example illustrates two choices in field 506, either of which may be selected by activating the associated Select field 507 or 508. Selecting field 504 in FIG. 16 shows the prior address with its associated precinct and polling place in field 516. Activating of the Yes field 517 results in the appropriate voter eligibility results screen being displayed.

Depending upon voter and address information entered in the searches, a screen 525 in FIG. 20 may advise that the voter does not live in this precinct, as in field 526. The pollworker may then be advised to direct the voter to another appropriate precinct. Alternatively, a screen 530 may advise that the voter cannot vote, as in field 531. Field 531 may also provide additional contact information to assist the voter in resolving any remaining issues.

Activating the DONE field in any of the foregoing screens, such as done field 532 in FIG. 21, returns to the menu screen 440 in FIG. 5 and the pollworker is ready for the next voter or voting issue that arises.

FIG. 22 illustrates an explanation screen 535 that assists the pollworker in identifying in field 536 any further action that may be required to resolve a voting issue.

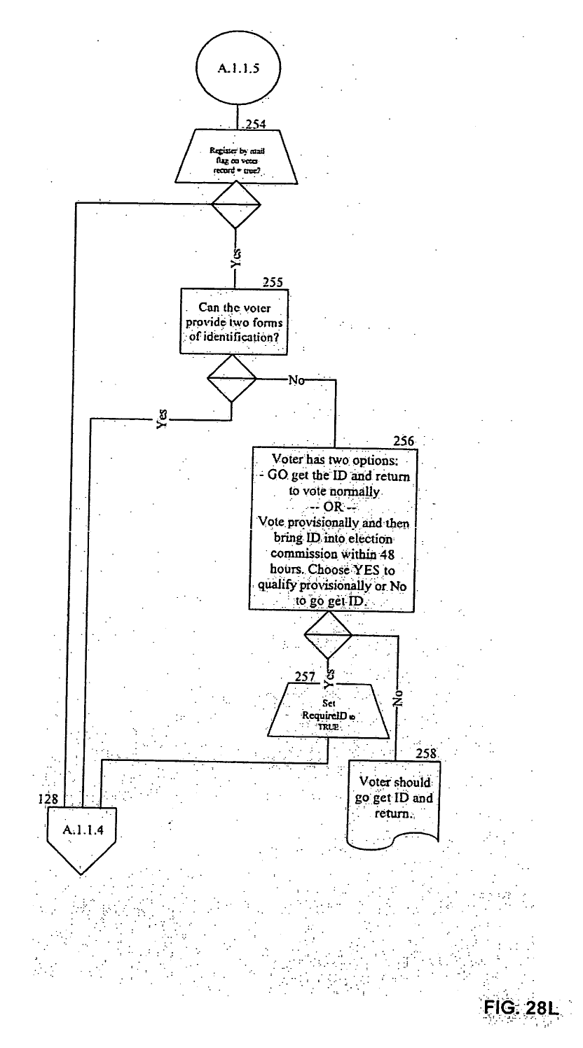

In accordance with another aspect of the present invention, an integrated help system assists the pollworker in resolving voting issues. For example, selecting the Help button 445 in the Menu screen 440 in FIG. 5 may display screen 545 in FIG. 24, which presents some key issues that may be selected by the pollworker by activation of the appropriate Select fields 547-550. For example, if Select field 547 for Absentee Voters is activated, the next screen 560 in FIG. 25 may present yet a submenu of topics that relate to absentee voting, any of which may be selected by the appropriate field 562-565.

Alternatively, if the pollworker selected the search icon 551 on screen 545 of FIG. 24, the screen 570 in FIG. 26 may appear with a search term field 571 for searching the help database by key word for the applicable election issue. Entry of key words may be made by simulated keyboard 572, with the search initiated by activating the search field 573. For example, during the course of Election Day, the vote tabulation equipment may get jammed. The pollworker starts the software and selects the help system, by pressing the Help button 445 on screen 440 in FIG. 5. The pollworker clicks the search icon 551 on screen 545 in FIG. 24, enters the phrase “ballot jam” in field 571 on screen 570 of FIG. 26, and clicks the Search button 573. The software displays a list of topics that contain these terms, as seen on screen 577 of FIG. 27A. One of the topic headlines is, “Ballot Jam on Election Morning” at 578. The pollworker clicks this topic 579 and the software displays a help topic detail screen 580 in FIG. 27B, which includes both a text explanation of how to clear a jam as well as a link to a video showing how to clear the tabulator 581. The pollworker clicks the show video button 581 to watch the video 576 in FIG. 27C and uses this information to clear the tabulator so the election can continue.

FIGS. 28A to 28P collectively contain an example of a flowchart of the election logic provided by the software of the present invention, which guides the pollworker to the correct voter eligibility result for a particular voter. FIG. 28A is concerned with some initial steps in the voter eligibility process. At block 188, a determination is made of whether the voter has a preprinted application in the regular poll book. If not, the process via connector A.1.1 to block 168 in FIG. 28B. If yes, block 202 determines if the voter registered by mail, as indicated by an envelope icon on the preprinted application. If yes at block 202, the voter is requested to provide two forms of identification at block 203. If no, the voter has two options. He/she may retrieve two identifications and return to vote, or he/she may vote provisionally and bring appropriate IDs to the election commission within 48 hours. The pollworker either enters yes and the voter leaves to get the required IDs (block 253) or enters no (block 238), and require ID is set to true.

If the ID requirement was set to true at block 238, if the voter could provide two forms of identification at block 203, or if the voter did not register by mail at block 202, the process moves to block 187 where the voter is asked if the address on the preprinted application is his/her current address. If not, the process moves via connector A.2 to block 123 in FIG. 28H. If the address is current at block 187, the voter is asked to sign the poll book at block 186 and a determination of a match of signatures is made. If a majority of election judges agree that the signatures match at block 184, the voter is permitted to vote on a full ballot at block 185. Otherwise, the voter may be permitted to vote on a provisional ballot and the user is instructed to submit a challenge affidavit to the election commission at block 183. If the signatures matched at block 186 and if the required ID was set to true at block 139, the voter is permitted to vote a full ballot at block 185. Otherwise, the voter can only vote a provisional ballot and provide proper ID within the set time limit at block 204.

With reference to the top of FIG. 28B, connector A.1.1 from FIG. 28A routes to block 168 where a voter lookup is performed. If a record is not found, the process moves to block 169 where the voter is queried about the possibility of a different name. If not, the voter is queried at block 170 about whether he/she is in active military service or is recently discharged from the military. If yes, the process moves via connector A.1.1.3 to block 136 in FIG. 28F, or, if no, via connector A.1.1.1 to block 120 in FIG. 28J. If a voter has a new name at block 169, a voter lookup is performed for the new name at block 171. If the name is the voter's current name, the process returns via connector A to block 188 in FIG. 28A. If the name is not the voter's new name, the process moves via connector A.1.1.5 to block 254 in FIG. 28L.

If the voter lookup was successful at block 168 and the voter registered by mail and there is not a flag on the voter record at block 249, the voter is asked whether the address is current at block 167. If not, the process moves via connector A.1.1.2 to block 158 in FIG. 28C. If the address is current, a determination is made of whether the address is in the subject precinct at block 166. If not, the voter is directed to the correct voting place at block 165. If the address is within the precinct, the voter is asked whether his/her name on the voting record is a current legal name at block 164. If not, the process moves via connector A.1.1.4 to block 128 in FIG. 28K. If the name is a current legal name, block 162 determines if the status of the name is active. If active and the required ID is not satisfied at block 262, the voter is permitted to vote provisionally, may have to execute an appropriate affidavit and may be required to provide satisfactory ID within the applicable time limit at block 261. If the ID requirement was satisfied at block 262, the voter is allowed to vote by full ballot, a special colored preprinted application form may be issued, and the voter may be required to execute an affidavit at block 161. If the voter's legal name was not active at block 162, a determination is made if the voter's legal name was suspended at block 163 or canceled at block 155. If so, the voter cannot vote (block 152) and may contact the jurisdiction for information. If not suspended or canceled and the ID requirements are satisfied at block 260, the voter may vote a provisional ballot at block 101. If the ID is not satisfied, the voter may be permitted to vote provisionally and provide proper ID within a time limit at block 259.

Returning to block 249 in FIG. 28B, if there is a flag on the voter record, the voter is requested to provide two forms of ID at block 250. If the ID is satisfied, the process continues to previously described block 167. If not, the voter is requested to go get the appropriate ID and return to vote (blocks 251 and 253), or the voter is permitted to vote provisionally and provide ID within a time limit (blocks 251 and 252).

Turning now to FIG. 28C, it will be recalled that connector A.1.1.2 came from block 167 in FIG. 28B. Block 158 determines if the address on file is a former address. If not, block 159 suggests that the wrong voter may have been identified and invites a new search. If a new search is not chosen, the process goes via connector A.1.1.1 to block 120 in FIG. 28J. If a new search is selected, the process goes via connector A.1.1 to block 168 in FIG. 28B.

If the address on file at block 158 is determined to be a former address, a determination is made at block 157 of whether the former address is in the subject precinct. If not, the process goes via connector A.1.1.2.1 to block 199 in FIG. 28E. If yes, the voter status is examined at block 190. If rejected (block 1560, the process goes via connector A.1.1.2.2 to block 119 in FIG. 28I. If the voter is canceled, the voter cannot vote and may contact the jurisdiction for more information (block 191). If the voter status is active or suspended (blocks 153 and 154), the voter is asked at block 151 when he/she moved. If the move was within 27 days (block 263) and voter ID is satisfied (block 263), the voter may vote a full ballot, execute an appropriate affidavit and have a colored preprinted application at block 149. If voter ID is not satisfied (block 264), the voter may vote a provisional ballot, execute an appropriate affidavit and provide adequate ID within a specified time at block 264.

If the voter moved within some other specified time (block 148) and ID is determined to be adequate (block 265), the voter may vote a full ballot, execute an appropriate affidavit and have a colored preprinted application at block 147. If voter ID is not satisfied (block 265), the voter may vote a provisional ballot, execute an appropriate affidavit and provide adequate ID within a specified time at block 266. If the voter is not sure that he/she transferred their voter registration to their new address at block 223, he/she cannot vote and he/she should contact the jurisdiction for more information at block 225. However, if the voter is sure about the transfer of voter registration to a new address, the process goes via connector A.1.1.2.3 to block 225 in FIG. 28M.

FIG. 28D deals with additional move issues. At block 146, the pollworker inquires when the voter moved. If within 30 days (block 145) and satisfactory ID (block 318) the voter is requested to sign a poll book at block 323. If the signatures match, the voter may vote a full ballot, complete a form and provide satisfactory ID within a prescribed period of time at block 319. If there are any issues about the match of signatures at block 323, the decision is subject to a majority of election judges at block 324. If the majority decision is that the signatures do not match, the voter may vote a full ballot for the former address, complete a form, execute a challenge affidavit and provide satisfactory ID within a time limit at block 325.

If the decision at block 145 is that the voter has not moved within the last 30 days, the voter is queried whether he/she lives within the county at block 216. If not, the voter cannot vote in this jurisdiction, but maybe able to vote in the county where he/she now lives (block 218). If the voter lives within the county, an election judge needs to investigate whether the address is within the county (block 217). If not, the voter cannot vote (block 220). At block 2198, the voter is again queried about transfer of voter registration. If yes, the voter may vote provisionally at their new polling place and the vote will be counted if the jurisdiction decides that the voter should have been registered at block 221. If the voter is not certain about transfer of voter registration (block 222), the voter cannot vote and he/she should contact the jurisdiction for further information.

FIG. 28E contains similar steps relating to the effect of recent moves on a voter's ability to vote, including whether the ballot will be full or provisional, or whether the voter will be unable to vote.

FIG. 28F is concerned with an address lookup search at block 136. Block 137 determines if the identified address can be found on a precinct map. If not, the voter cannot vote in this precinct (block 143) and may contact the jurisdiction for further information. If the address is found on a precinct map at block 137, the voter may vote a full ballot, a colored preprinted application is used and a special form may be used (block 138). If the address is identified as within the precinct at block 135 and the voter's ID is satisfactory at block 291, the voter may vote a full ballot, a colored preprinted application is used and a special form may be used (block 103). If the address is not within the precinct at block 135, the voter is directed to the correct polling place at block 134.

FIG. 28G is directed to several situations involving whether voter signatures match. If the signatures match at block 350 or if a majority of judges decide that the signatures match at block 356, the voter may vote a provisional ballot style based on the poll book for the voter's former address, execute an appropriate affidavit and provide satisfactory ID within a time limit at block 268. Otherwise, if signatures do not match at block 356, the voter may vote a provisional ballot style based on the poll book for the voter's former address, execute an appropriate affidavit, provide satisfactory ID within a time limit and execute a challenge affidavit at block 362. The remaining flowcharts in FIG. 28G are similar but with slightly different voting conditions.

FIG. 28H is concerned with identifying whether an address from an address lookup search is within the precinct and whether voter signatures match. Thus, it is similar to the previously described flowcharts in FIGS. 28F and 28G and can be understood from the foregoing descriptions of those Figures.

FIG. 28I is concerned with whether a voter's registration has been transferred to their new address. FIG. 28I is similar to portions of FIG. 28D. Thus, FIG. 28I should be self-explanatory in view of the foregoing descriptions.

FIG. 28J is concerned with whether a voter is registered in the subject county (block 120). If not, the voter cannot vote (block 215). If registered, the remainder of this flowchart is similar to the previously described flowchart in FIG. 28F and should be self-explanatory in view of foregoing descriptions.

The flowchart in FIG. 28K is concerned with a voter's change of name. Block 128 inquires when the change in name occurred. If the name change occurred within 30 days (block 127) and voter ID is satisfactory, the voter may vote by full ballot, use a colored preprinted application and execute an appropriate affidavit (block 198). If the ID is insufficient, the voter will need to bring satisfactory ID to the election commission within a time limit (block 308). If the voter has reregistered under his/her new name (block 126), the address is still within the precinct (block 106) and ID is satisfactory (block 3090, the voter may vote by a provisional ballot and provide a provisional affidavit (block 193). If the voter is unsure or has not reregistered, he/she cannot vote (block 141).

FIG. 28L is concerned with voters who have registered by mail. If the voter can provide satisfactory ID (block 255), the process goes via connector A.1.1.4 to block 128 in FIG. 28K. If the ID is not satisfactory, the voter may get the ID and return, or the voter may vote provisionally and bring suitable ID to the election commission within the prescribed time period (block 256).

FIG. 28M is concerned with an address lookup search and whether the address is within the precinct. Thus, the flowchart in FIG. 28M is similar to previously presented flowcharts such as that in FIGS. 28C and 28F. The flowchart in FIG. 28M should therefore be self-explanatory in view of foregoing descriptions.

FIG. 28N is a flowchart for an address lookup (block 3). A list of addresses is provided at block 4. The pollworker can try again, which returns to block 3, give up and return to the menu screen in FIG. 5 if an appropriate address is not found (block 1), or select an address which may display further address details (block 5). If the address displayed at block 5 is incorrect, the process returns to the list of addresses provided at block 4. If the address is correct, block 11 determines if the address is in the subject precinct. Confirmation of the address within the precinct is at block 22. If the address is not in the precinct (block 23), a correct polling place for the address is provided at block 28.

FIG. 28O is related to FIG. 28N, but this search is directed to a voter (block 14) instead of the address search conducted in FIG. 28N. A list of voters is provided at block 15. The pollworker can try again, which returns to block 14, give up and return to the menu screen in FIG. 5 if an appropriate voter is not found (block 18), or select an voter which may display further voter details (block 16). If the voter displayed at block 16 is incorrect, the process returns to the list of voters provided at block 15. Details on the appropriate polling place may be provided for the selected voter at block 17. If the correct voter was selected at block 16, block 24 determines if the voter's address is in the subject precinct. Confirmation that the voter was found within the precinct occurs at block 13. If the voter's address is not in the precinct (block 25), a correct polling place for the voter is provided at block 26.

The flowchart in FIG. 28P is concerned with both voters who may have moved and with voter signature matching issues. It is similar to previously described FIGS. 28D, 28E, 28G and 28H. Thus, FIG. 28P can be readily understood from the foregoing descriptions.

FIG. 29 is a flow chart of the logic provided by the software of the present invention for the election decision support process. In block 51, menu choices are supplied from a menu table. At block 52, one of the menu choices is selected, such as from menu screen 440 in FIG. 5. A lookup step is then performed in the step table at block 53. At block 54, the appropriate step type is determined and an appropriate screen for the step is displayed. However, if no step is to be determined, the process returns the initial block 51.

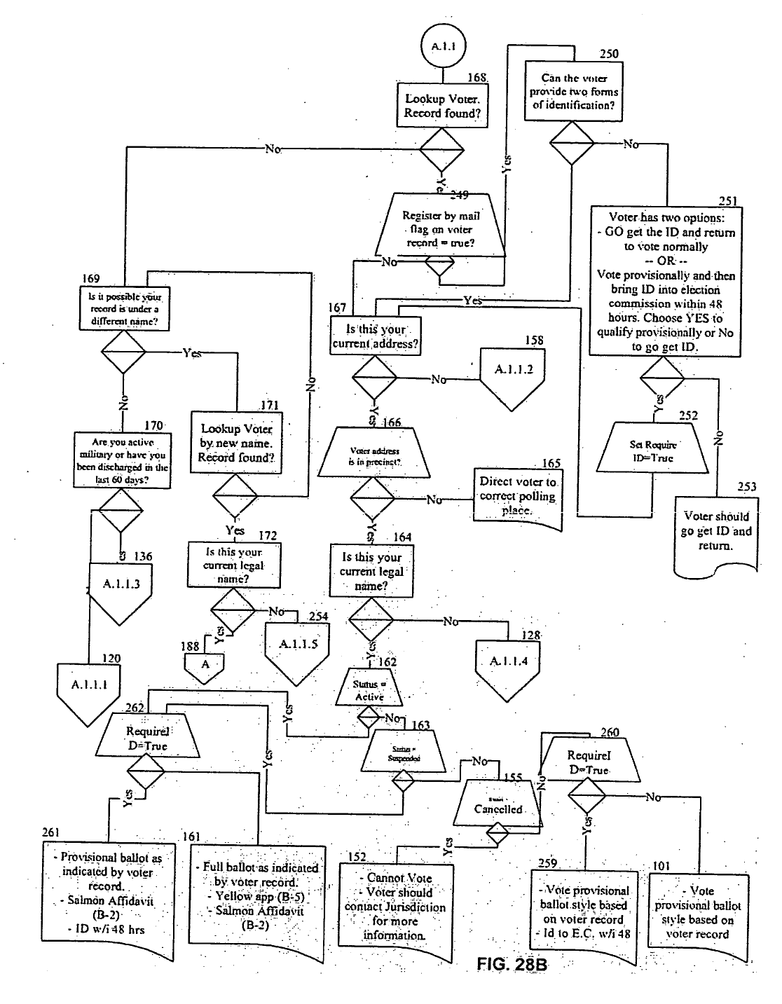

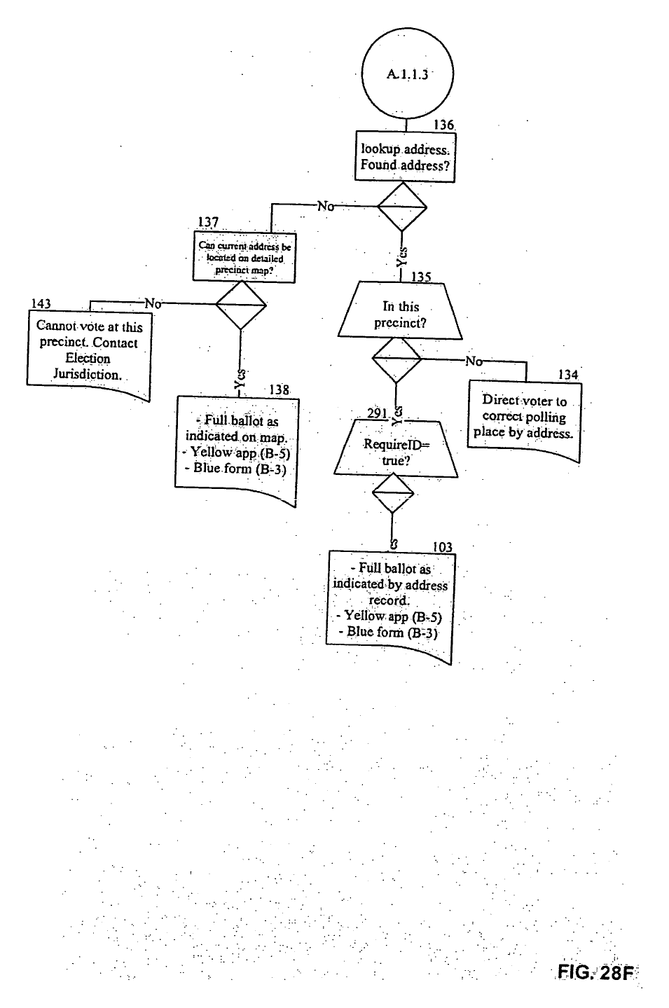

Block 55 of FIG. 29 represents an action step screen which displays a list of actions for the user to complete, such as screen 520 in FIG. 19. When the user has completed the actions, he/she may select a DONE button or field to continue to the next step, which is a lookup step for a yes entry at block 61. Block 56 represents an input date screen, such as screen 485 in FIG. 13. After the appropriate date is entered by the user, an OKAY button or field is selected to move on to the next step which is a lookup step for a yes entry at block 61. Block 57 represents a decision step. No change is made in the display, but the next step is determined based upon available data in global variables and the voter address record. After the next step is determined, the process automatically moves to the next step which is a lookup step for a yes entry at block 61 or a lookup step for a no entry at block 62. Block 58 determines the appropriate lookup voter screen depending upon user input, such as at FIGS. 7A-7D. If the user enters a yes response to indicate that the desired voter has been found, such as at field 473 in FIG. 7D, the process moves to a lookup step for a yes entry at block 61. If the user enters a no response indicating that the desired voter was not found, such as field 474 in FIG. 7D, the process moves to a lookup step for a no entry at block 62. Block 59 determines the appropriate lookup address screen depending upon user input, such as in FIGS. 15-18. If the user enters a yes response to indicate that the desired address has been found, such as field 517 in FIG. 18, the process moves to a lookup step for a yes entry at block 61. If the user enters a no response indicating that the desired address was not found, such as field 518 in FIG. 18, the process moves to a lookup step for a no entry at block 62. Block 60 determines the responses for yes, no, or unsure user responses, such as in FIGS. 6, 12 and 14. The appropriate text is displayed on screen in response to user inputs, and global if called for in data as well, such as field 491 in FIG. 14. The process moves to a lookup step for a yes entry at block 61, such as field 449 in FIG. 6, to a lookup step for a no entry at block 62, such as field 450 in FIG. 6, or to a lookup step for an unsure entry at block 63, such as field 451 in FIG. 6.

After conducting the next lookup step for yes at block 61, for no at block 62 or for unsure at block 63, the process moves to the step 1D block 64. If the step 1D is zero, the process moves to the menu choice block 51. If the step 1D is not zero, the process moves to block 54 to determine the next step type.

While particular embodiments of the invention have been shown and described, it will be obvious to those skilled in the art that changes and modifications may be made therein without departing from the invention in its broader aspects.

1. A method for determining voter eligibility in an election on an electronic device, said method comprising the steps of:
confirming the election and an election date on a screen provided by the device;
selecting the proper precinct for the election on a screen provided by the device; and
selecting a desired voter election decision process on a menu screen provided by the device.

2. The method of determining voter eligibility in accordance with claim 1, said method comprising the additional steps of:
providing a voter lookup screen on the device;
initiating a voter lookup search on the device; and
providing a voter search result list from conducting a search on the voter lookup screen.

3. The method of determining voter eligibility in accordance with claim 2, said method comprising the additional steps of:
providing detailed information on a selected voter in the voter search result list.

4. The method of determining voter eligibility in accordance with claim 2, said method comprising the additional steps of:
initiating a broadened voter lookup search on the device; and
providing a voter search result list from conducting a broadened search on the voter lookup screen.

5. The method of determining voter eligibility in accordance with claim 1, said method comprising the additional step of:
providing detailed information for a particular polling place.

6. The method of determining voter eligibility in accordance with claim 1, said method comprising the additional step of:
providing a screen for responding to a Yes, No, or Maybe question posed during the election decision process.

7. The method of determining voter eligibility in accordance with claim 2, said method comprising the additional step of:
providing a screen for responding to a when did you move inquiry.

8. The method of determining voter eligibility in accordance with claim 2, said method comprising the additional step of:
providing a screen for responding to a legal name inquiry.

9. The method of determining voter eligibility in accordance with claim 2, said method comprising the additional step of:
providing an address lookup screen to determine a voter's correct voting location.

10. The method of determining voter eligibility in accordance with claim 2, said method comprising the additional step of:
providing results from the address lookup search.

11. The method of determining voter eligibility in accordance with claim 2, said method comprising the additional step of:
providing results from a broadened address lookup search.

12. The method of determining voter eligibility in accordance with claim 2, said method comprising the additional step of:
providing further detail about a selected voter in the lookup results list.

13. The method of determining voter eligibility in accordance with claim 2, said method comprising the additional step of:
identifying that the voter is eligible to vote in a different precinct as a result of the voter eligibility interview process.

14. The method of determining voter eligibility in accordance with claim 2, said method comprising the additional step of:
identifying that the voter is only eligible to vote provisionally.

15. The method of determining voter eligibility in accordance with claim 2, said method comprising the additional step of:
identifying that the voter is not eligible to vote in this election.

16. The method of determining voter eligibility in accordance with claim 1, said method comprising the additional step of:
providing a menu screen with selectable election help topics.

17. The method of determining voter eligibility in accordance with claim 16, said method comprising the additional step of:
providing help information on a topic selected from the menu screen.

18. The method of determining voter eligibility in accordance with claim 16, said method comprising the additional step of:
displaying an integrated video on a selected election topic.

19. A computer readable medium having computer program code stored thereon, the computer program code for determining the eligibility of a voter in an election, comprising:
a first code segment for confirming an election and an election date;
a second code segment for selecting the proper precinct for the election; and,
a third code segment for selecting a desired voter election decision process from a menu screen.

20. The computer readable medium in accordance with claim 19, further comprising:
a fourth code segment for providing a voter lookup screen;
a fifth code segment for initiating a voter lookup search; and
a sixth code segment for providing a voter search result list.

21. The computer readable medium in accordance with claim 20, further comprising:
a seventh code segment for providing detailed information on a selected voter in the voter search result list.

22. The computer readable medium in accordance with claim 20, further comprising:
an eighth code segment for responding to a Yes, No or Maybe question posed during the election decision process.

23. The computer readable medium in accordance with claim 20 further comprising:
a ninth code segment for initiating a broadened voter lookup search; and
a tenth code segment for providing a broadened voter search results.

24. The computer readable medium in accordance with claim 19 further comprising:
an eleventh code segment for providing detailed information about a particular polling place.

25. The computer readable medium in accordance with claim 20, further comprising:
a twelfth code segment for providing a screen in response to a when did you move inquiry.

26. The computer readable medium in accordance with claim 20, further comprising:
a thirteenth code segment for providing a screen in response to a legal name inquiry.

27. The computer readable medium in accordance with claim 20, further comprising:
a fourteenth code segment for providing an address lookup screen to determine a voter's correct voting location.

28. The computer readable medium in accordance with claim 20, further comprising:
a fifteenth code segment for providing results from an address lookup search.

29. The computer readable medium in accordance with claim 20, further comprising:
a sixteenth code segment for providing further detail about a selected voter in the lookup results list.

30. The computer readable medium in accordance with claim 20, further comprising:
a seventeenth code segment for identifying that the voter is eligible to vote in a different precinct.

31. The computer readable medium in accordance with claim 20, further comprising:
an eighteenth code segment for identifying that the voter is only eligible to vote provisionally.

32. The computer readable medium in accordance with claim 20, further comprising:
a nineteenth code segment for identifying that the voter is not eligible to vote in this election.

33. The computer readable medium in accordance with claim 19, further comprising:
a twentieth code segment for providing a menu screen with selectable election help topics.

34. The computer readable medium in accordance with claim 33, further comprising:
a twenty-first code segment for providing help information on an election help topic selected from the menu screen.

35. The computer readable medium in accordance with claim 33, further comprising:
a twenty-second code segment for displaying an integrated video on an election help topic selected from the menu screen.

36. A method of providing decision support program control on an electronic device with a display, said electronic device having access to available data, said method comprising the steps of:
providing a menu of selectable choices on the display;
selecting one of the choices in the menu;
looking up a step associated with the selected choice in a step table;
determining the step type from the step table;
displaying nothing on the display if the determined step type is a decision step and determining the next step based upon user input and the available data;
displaying a list of actions on the display if the determined step type is an action step and determining the next step based upon user input; and
returning to the menu if the step 1D is zero or determining the next step type from the step table if the step 1D is not zero.

37. The method of providing decision support program control in accordance with claim 36, said method further comprising the steps of:
displaying a voter lookup screen on the display if the determined step type is a voter lookup step;
determining if the user found a voter in the voter lookup step; and
returning to the menu if the step 1D is zero or determining the next step type from the step table if the step 1D is not zero.

38. The method of providing decision support program control in accordance with claim 37, said method further comprising the step of:
providing a broadened voter lookup step if the user input is that none of the voters identified in the voter lookup step is the desired voter.

39. The method of providing decision support program control in accordance with claim 36, said method further comprising the steps of:
displaying an address lookup screen on the display if the determined step type is an address lookup step;
determining if the user found an address in the address lookup step;
providing a step 1D; and
returning to the menu if the step 1D is zero or determining the next step type from the step table if the step 1D is not zero.

40. The method of providing decision support program control in accordance with claim 39, said method further comprising the step of:
providing a broadened address lookup step if the user input is that none of the addresses identified in the address lookup step is the desired address.

41. The method of providing decision support program control in accordance with claim 36, said method further comprising the steps of:
displaying text on the display if the determined step type is a Yes, No or Unsure step;
providing selections on the display for Yes, No or Unsure entries by the user;
looking up the next step based upon entry by the user of Yes, No or Unsure; and
returning to the menu if the step 1D is zero or determining the next step type from the step table if the step 1D is not zero.
